(19) United States
(12) Patent Application Publication
(10) Pub. No.: US 2026/0289407 A1
(43) Pub. Date: Sep. 24, 2026

(54) LANGUAGE-BASED CROSS-MODALITY TRANSFER SYSTEM FOR GENERATING VIRTUAL DATA TO ENHANCE ACTIVITY RECOGNITION

(71) Applicant: Georgia Tech Research Corporation, Atlanta, GA (US)

(72) Inventors: Zikang Leng, Atlanta, GA (US); Amitrajit Bhattacharjee, Atlanta, GA (US); Hrudhai Rajasekhar, Atlanta, GA (US); Lizhe Zhang, Atlanta, GA (US); Elizabeth Bruda, Atlanta, GA (US); Hyeokhyen Kwon, Atlanta, GA (US); Thomas Ploetz, Atlanta, GA (US)

(21) Appl. No.: 19/566,099

(22) Filed: Mar. 13, 2026

Related U.S. Application Data
(60) Provisional application No. 63/771,410, filed on Mar. 13, 2025.

(51) Int. Cl. G06N 20/00

(52) U.S. Cl. CPC G06N 20/00

(57) ABSTRACT

An exemplary system and method are disclosed for generating training data for artificial intelligence (AI) or machine learning (ML) models to detect or recognize activities of a subject. In one implementation, an example method includes generating, via a motion synthesis model and as a first trained AI model, a set of motion sequence data objects representing motion sequences corresponding with the plurality of activity descriptions, where the generation of the set of motion sequence data objects includes applying an iterative data-variability evaluation operation.

### RELATED APPLICATION

This application claims priority to, and the benefit of, U.S. Provisional Patent Application No. 63/771,410, filed Mar. 13, 2025, entitled “LANGUAGE-BASED CROSS-MODALITY TRANSFER SYSTEM FOR GENERATING VIRTUAL INERTIAL MEASUREMENT UNIT DATA TO ENHANCE HUMAN ACTIVITY RECOGNITION,” which is incorporated by reference herein in its entirety.

### BACKGROUND

Activity recognition (e.g., human activity recognition (HAR)) is used across various domains, including fitness tracking, health monitoring, sign language recognition, and event identification (e.g., vehicular accidents). Activity recognition is typically achieved through supervised learning methods that classify segmented data streams into activities of interest. The effectiveness of the supervised learning methods relies on the availability of annotated datasets. However, a challenge that activity recognition technologies face is the lack of large-scale, labeled datasets due to the expensive annotation process, the need for domain experts, and privacy concerns.

There is a benefit to improving the generation of datasets for training artificial intelligence (AI) and machine learning (ML) models for activity recognition.

### SUMMARY

An exemplary system and method are disclosed for generating training data for artificial intelligence (AI) or machine learning (ML) models to detect or recognize activities of a subject (e.g., human, animal). Current activity recognition models that rely on sensors often lack labeled training data due to the high cost, time burden, and privacy concerns associated with data collection. The accuracy and generalizability of current activity recognition models can also be degraded by inconsistent execution of activities, ambiguous annotations, and sensor noise. Another challenge in training AI or ML models is assessing the appropriate quantity and diversity of data required for a particular training objective. As a result, conventional methods may utilize more data than is necessary and/or lack sufficient diversity to ensure optimal results.

The exemplary system and method address the above-discussed limitations by facilitating cross-modality transfer from natural-language activity descriptions to synthesized training data (e.g., sensor data) for the activity recognition models. Employing large language models (LLMs) and motion-synthesis techniques, the exemplary system and method can generate virtual sensor signals that emulate real-world activity patterns without the need for manual data acquisition. In some implementations, the exemplary system and method can (i) enhance, via a motion filtering operation, the semantic relevance of generated sensor data, and (ii) optimize, via a data-variability evaluation operation, the sensor data generation process to increase the variety of the training data and reduce computational overhead. As a result, the exemplary system and method can optimize and reduce the training resources required for activity recognition applications.

Compared to current data collection methods, the exemplary system and method can eliminate reliance on large-scale datasets, reduce computational and annotation costs, and improve the robustness of activity recognition models by generating diverse, contextually relevant virtual training data. The automated, scalable nature of the exemplary system and method can enable rapid dataset expansion that surpasses the efficiency and scope of current methods.

The exemplary system and method can provide broad commercial applicability, including healthcare monitoring, rehabilitation assessment, fitness and sports analytics, smart home activity recognition, sign language interpretation, augmented and virtual reality systems, and workplace safety monitoring. By providing a mechanism for reliably generating training data for activity recognition without the logistical constraints of physical sensing, the exemplary system and method can facilitate the deployment of more capable, adaptable, and cost-effective activity-recognition models across multiple industries.

In an aspect, a system for generating training data for artificial intelligence (AI) or machine learning (ML) models to detect or recognize an activity of a subject (e.g., human, animal, etc.) is disclosed comprising: a controller including: a processor; and a memory having instructions stored thereon, wherein execution of the instructions causes the processor to: receive a first dataset including a plurality of activity descriptions for the subject; generate, via a motion synthesis model, as a first trained AI model, a set of motion sequence data objects representing motion sequences corresponding with the plurality of activity descriptions, wherein each motion sequence data object represents a motion within the motion sequences, and wherein the generation of the set of motion sequence data objects includes an iterative data-variability evaluation operation; generate, using the generated set of motion sequence data objects, a second dataset (e.g., virtual IMU data) including a set of properties of each motion sequence; and output the generated second dataset, wherein the output generated second data is subsequently used for training the AI or ML models to detect or recognize the activity of the subject.

In some embodiments, the motion synthesis model is a neural network trained using a dataset (e.g., HumanML3D) including motion sequence data objects acquired from a set of subjects (e.g., humans, animals) and coupled with corresponding descriptions of activities performed by the set of subjects.

In some embodiments, the received first dataset is generated, via a second trained AI model (e.g., LLM, Sentence Transformer), using data representing name or type of the activity of the subject as an input, wherein the second trained AI model is a large language model (LLM) trained using a dataset (e.g., text corpora) including descriptions of activities performed by a set of subjects (e.g., humans, animals).

In some embodiments, the iterative data-variability evaluation operation comprises: generating, in a given iteration, vectorial representations (e.g., embeddings) for the plurality of activity descriptions, wherein each vectorial representation includes semantic and syntactic data of a respective description (e.g., data point) within the first dataset, and wherein the vectorial representations form one or more vectorial clusters; determining, in the given iteration, a diversity score value (e.g., absolute diversity metric) representing variability among the generated vectorial representations in the given iteration, including (i) distributions of the one or more vectorial clusters and (ii) spatial distances (e.g., Euclidean distances) between centers of vectorial clusters and respective vectorial representations therein; determining a difference (e.g., comparative diversity metric) between the determined diversity score value in the given iteration and a diversity score value in a previous iteration; in response to the determined difference exceeding a variability threshold among the generated vectorial representations, generating, in subsequent iterations, additional activity descriptions until a difference in diversity score values of two consecutive subsequent iterations fails to exceed the variability threshold.

In some embodiments, the generation of the set of motion sequence data objects includes a second iterative operation (e.g., data-variability evaluation operation) including: generating, in a given iteration, vectorial representations (e.g., embeddings) for the set of motion sequence data objects, wherein each vectorial representation corresponds to a respective motion sequence data object, and wherein the vectorial representations form one or more vectorial clusters; determining, in the given iteration, a diversity score value representing variability among the generated vectorial representations in the given iteration, including (i) distributions of the one or more vectorial clusters and (ii) spatial distances (e.g., Euclidean distances) between centers of vectorial clusters and respective vectorial representations therein; determining a difference between the determined diversity score value in the given iteration and a diversity score value in a previous iteration; in response to the determined difference exceeding a variability threshold among the generated vectorial representations (e.g., data saturation not yet reached), generating, in subsequent iterations, additional motion sequence data objects until a difference in diversity score values in two consecutive subsequent iterations fails to exceed the variability threshold (e.g., data saturation reached), wherein the variability threshold is a predefined value or a value determined based on convergence of diversity score values across previous iterations.

In some embodiments, the execution of the instructions further causes the processor to remove, via a motion filtering operation, motion sequence data objects inconsistent with the plurality of activity descriptions, wherein the motion filtering operation comprises: receiving the generated set of motion sequence data objects; encoding, via a third trained AI model (e.g., motion captioning model, MotionGPT), the generated set of motion sequence data objects into a set of tokens (e.g., learnable motion codebook for a motion vocabulary), each token representing a respective motion sequence data object, wherein the third trained AI model was trained using a language dataset coupled with motion sequence data acquired from a set of people; generating, via the third trained AI model, a set of motion descriptions (e.g., motion captions), as input to the second trained AI model, for the generated set of motion sequence data objects encoded in the generated set of tokens; determining, via the second trained AI model, one or more motion descriptions within the generated set of motion descriptions as being inconsistent with the plurality of activity descriptions; and removing motion sequence data objects associated with the one or more motion descriptions determined as being inconsistent with the plurality of activity descriptions.

In some embodiments, the determining of the one or more motion descriptions as being inconsistent with the plurality of activity descriptions comprises: labeling motion descriptions within the generated set of motion descriptions (e.g., motion captions) with binary classification values (e.g., yes/no, 1/0), including a first binary classification value, and wherein the one or more motion descriptions determined as being inconsistent with the plurality of activity descriptions are labeled with the first binary classification value.

In some embodiments, the determining of the one or more motion descriptions as being inconsistent with the plurality of activity descriptions is based on one or more evaluation metrics, including similarity score values between the one or more motion descriptions and the plurality of activity descriptions.

In some embodiments, the set of properties of each motion sequence includes acceleration property values, angular velocity property values, orientation property values, magnetometry property values, or a combination thereof.

In some embodiments, the controller is implemented on a mobile device (e.g., computer).

In some embodiments, the controller is implemented on a remote device located on a cloud infrastructure.

In some embodiments, the execution of the instructions is implemented in an agentic AI pipeline operation including at least one trained AI model selected from the group comprising the first trained AI model, the second trained AI model, and the third trained AI model.

In another aspect, a non-transitory computer-readable medium having instructions stored thereon is disclosed, wherein execution of the instructions causes a processor to: receive a first dataset including a plurality of activity descriptions for a subject (e.g., human, animal); generate, via a motion synthesis model, as a first trained AI model, a set of motion sequence data objects representing motion sequences corresponding with the plurality of activity descriptions, wherein each motion sequence data object represents a motion within the motion sequences, and wherein the generation of the set of motion sequence data objects includes an iterative data-variability evaluation operation; generate, using the generated set of motion sequence data objects, a second dataset (e.g., virtual IMU data) including a set of properties of each motion sequence; and output the generated second dataset, wherein the output generated second data is subsequently used for training artificial intelligence (AI) or machine learning (ML) models to detect or recognize the activity of the subject.

In some embodiments, the motion synthesis model is a neural network trained using a dataset (e.g., HumanML3D) including motion sequence data objects acquired from a set of subjects (e.g., humans, animals) and coupled with corresponding descriptions of activities performed by the set of subjects.

In some embodiments, the received first dataset is generated, via a second trained AI model (e.g., LLM, Sentence Transformer), using data representing name or type of the activity of the subject as an input, wherein the second trained AI model is a large language model (LLM) trained using a dataset (e.g., text corpora) including descriptions of activities performed by a set of subjects (e.g., humans, animals).

In some embodiments, the iterative data-variability evaluation operation comprises: generating, in a given iteration, vectorial representations (e.g., embeddings) for the plurality of activity descriptions, wherein each vectorial representation includes semantic and syntactic data of a respective description (e.g., data point) within the first dataset, and wherein the vectorial representations form one or more vectorial clusters; determining, in the given iteration, a diversity score value (e.g., absolute diversity metric) representing variability among the generated vectorial representations in the given iteration, including (i) distributions of the one or more vectorial clusters and (ii) spatial distances (e.g., Euclidean distances) between centers of vectorial clusters and respective vectorial representations therein; determining a difference (e.g., comparative diversity metric) between the determined diversity score value in the given iteration and a diversity score value in a previous iteration; in response to the determined difference exceeding a variability threshold among the generated vectorial representations, generating, in subsequent iterations, additional activity descriptions until a difference in diversity score values of two consecutive subsequent iterations fails to exceed the variability threshold.

In some embodiments, the generation of the set of motion sequence data objects includes a second iterative operation (e.g., data-variability evaluation operation) including: generating, in a given iteration, vectorial representations (e.g., embeddings) for the set of motion sequence data objects, wherein each vectorial representation corresponds to a respective motion sequence data object, and wherein the vectorial representations form one or more vectorial clusters; determining, in the given iteration, a diversity score value representing variability among the generated vectorial representations in the given iteration, including (i) distributions of the one or more vectorial clusters and (ii) spatial distances (e.g., Euclidean distances) between centers of vectorial clusters and respective vectorial representations therein; determining a difference between the determined diversity score value in the given iteration and a diversity score value in a previous iteration; in response to the determined difference exceeding a variability threshold among the generated vectorial representations (e.g., data saturation not yet reached), generating, in subsequent iterations, additional motion sequence data objects until a difference in diversity score values in two consecutive subsequent iterations fails to exceed the variability threshold (e.g., data saturation reached).

In some embodiments, the execution of the instructions further causes the processor to remove, via a motion filtering operation, motion sequence data objects inconsistent with the plurality of activity descriptions, wherein the motion filtering operation comprises: receiving the generated set of motion sequence data objects; encoding, via a third trained AI model (e.g., motion captioning model, MotionGPT), the generated set of motion sequence data objects into a set of tokens (e.g., learnable motion codebook for a motion vocabulary), each token representing a respective motion sequence data object, wherein the third trained AI model was trained using a language dataset coupled with motion sequence data acquired from a set of people; generating, via the third trained AI model, a set of motion descriptions (e.g., motion captions), as input to the second trained AI model, for the generated set of motion sequence data objects encoded in the generated set of tokens; determining, via the second trained AI model, one or more motion descriptions within the generated set of motion descriptions as being inconsistent with the plurality of activity descriptions; and removing motion sequence data objects associated with the one or more motion descriptions determined as being inconsistent with the plurality of activity descriptions.

In some embodiments, the determining of the one or more motion descriptions as being inconsistent with the plurality of activity descriptions comprises: labeling motion descriptions within the generated set of motion descriptions (e.g., motion captions) with binary classification values (e.g., yes/no, 1/0), including a first binary classification value, and wherein the one or more motion descriptions determined as being inconsistent with the plurality of activity descriptions are labeled with the first binary classification value.

In yet another aspect, a method for generating training data for artificial intelligence (AI) or machine learning (ML) models to detect or recognize an activity of a subject (e.g., human, animal, etc.) is disclosed comprising: receiving, via a processor, a first dataset including a plurality of activity descriptions for the subject; generating, via a motion synthesis model, as a first trained AI model, a set of motion sequence data objects representing motion sequences corresponding with the plurality of activity descriptions, wherein each motion sequence data object represents a motion within the motion sequences, and wherein the generation of the set of motion sequence data objects includes an iterative data-variability evaluation operation; generating, using the generated set of motion sequence data objects, a second dataset (e.g., virtual IMU data) including a set of properties of each motion sequence; and outputting, via the processor, the generated second dataset, wherein the output generated second data is subsequently used for training the AI or ML models to detect or recognize the activity of the subject.

In some embodiments, the iterative data-variability evaluation operation comprises: generating, in a given iteration, vectorial representations (e.g., embeddings) for the plurality of activity descriptions, wherein each vectorial representation includes semantic and syntactic data of a respective description (e.g., data point) within the first dataset, and wherein the vectorial representations form one or more vectorial clusters; determining, in the given iteration, a diversity score value (e.g., absolute diversity metric) representing variability among the generated vectorial representations in the given iteration, including (i) distributions of the one or more vectorial clusters and (ii) spatial distances (e.g., Euclidean distances) between centers of vectorial clusters and respective vectorial representations therein; determining, via the processor, a difference (e.g., comparative diversity metric) between the determined diversity score value in the given iteration and a diversity score value in a previous iteration; in response to the determined difference exceeding a variability threshold among the generated vectorial representations, generating, in subsequent iterations, additional activity descriptions until a difference in diversity score values of two consecutive subsequent iterations fails to exceed the variability threshold.

### BRIEF DESCRIPTION OF DRAWINGS

FIG. 1A, FIG. 1B, FIG. 1C, FIG. 1D, and FIG. 1E each shows an example system for generating training data for artificial intelligence (AI) or machine learning (ML) models to detect or recognize an activity of a subject, in accordance with an illustrative embodiment.

FIG. 2A and FIG. 2B each shows an example method for operating the exemplary system, in accordance with an illustrative embodiment.

FIG. 2C shows an example iterative data-variability evaluation method for operating a generation of a plurality of activity descriptions described in FIG. 2B.

FIG. 3A and FIG. 3B each shows an example implementation of the exemplary system described in FIG. 1B and FIG. 1E, respectively.

FIG. 3C shows an example algorithmic implementation of a data-variability evaluation operation to determine a stopping point (e.g., saturation point) for a generation of activity descriptions in the exemplary system, in accordance with an illustrative embodiment.

FIG. 3D shows an example motion filtering operation in the exemplary system, in accordance with an illustrative embodiment.

FIG. 3E shows example message, motion captions, and binary labels generated by a trained AI model during a motion filtering operation in the exemplary system, in accordance with an illustrative embodiment.

FIG. 4 shows human motion sequences generated by a motion synthesis model in the exemplary system, in accordance with an illustrative embodiment.

### DETAILED DESCRIPTION

Some references, which may include various patents, patent applications, and publications, are cited in a reference list and discussed in the disclosure provided herein. The citation and/or discussion of such references is provided merely to clarify the description of the disclosed technology and is not an admission that any such reference is “prior art” to any aspects of the disclosed technology described herein. In terms of notation, “[n]” corresponds to the nth reference in the list. For example, [1] refers to the first reference in the list. All references cited and discussed in this specification are incorporated herein by reference in their entirety and to the same extent as if each reference were individually incorporated by reference.

### Example System

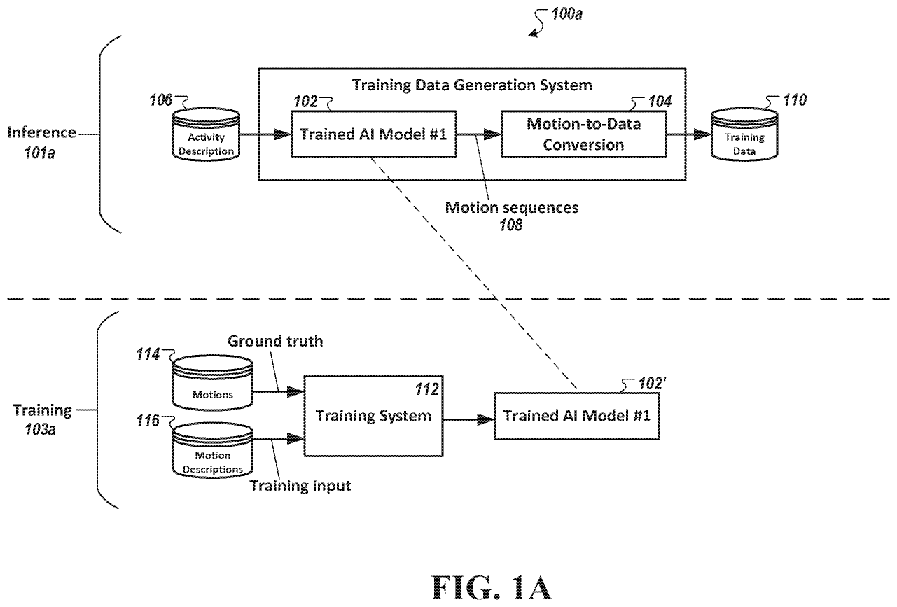

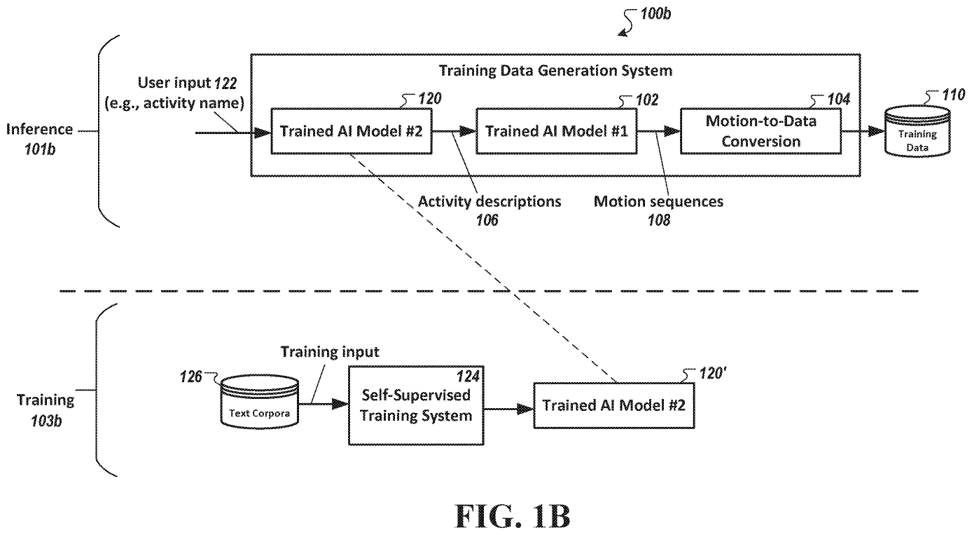

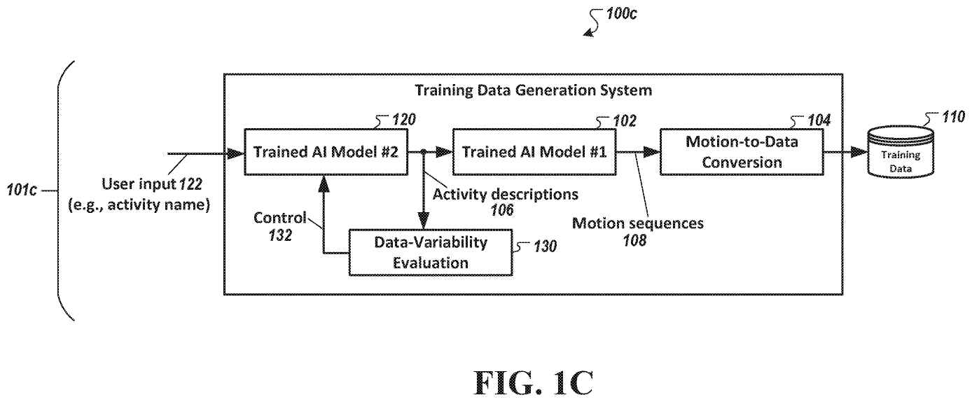

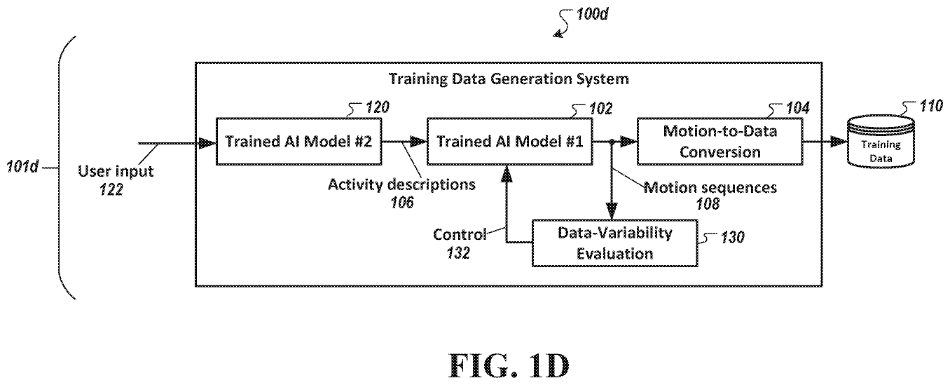

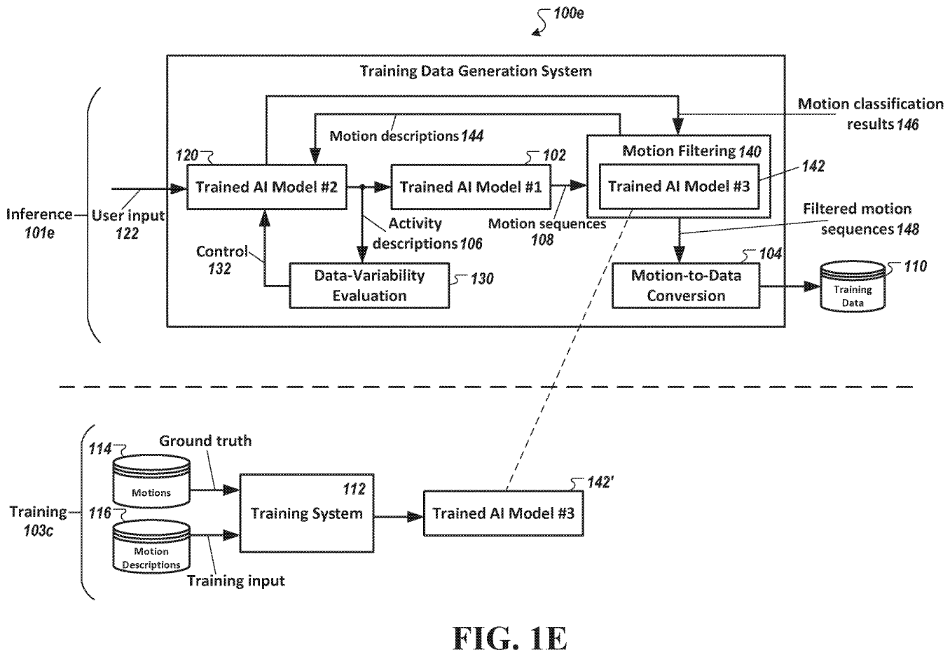

FIGS. 1A-1E each show an example system 100 (shown as 100a, 100b, 100c, 100d, 100e) for generating training data for artificial intelligence (AI) or machine learning (ML) models to detect or recognize an activity of a subject (e.g., human, animal, etc.), in accordance with an illustrative embodiment. As shown, the exemplary system 100 (e.g., 100a, 100b, 100c, 100d, 100e) includes at least one trained AI model (e.g., 102) and a motion-to-data conversion operation (e.g., 104) during an inference stage 101 (e.g., 101a, 101b, 101c, 101d, 101e), and each of the at least one trained AI model is trained during a training stage 103 (e.g., 103a, 103b, 103c).

Inference (101). In FIG. 1A, the exemplary system 100a includes a trained AI model 102 (shown as trained AI model #1) and a motion-to-data conversion operation 104. In some embodiments, the trained AI model 102 is a motion synthesis model, such as T2M-GPT [79], MotionGPT [26], MotionDiffuse [80], and ReMoDiffuse [81].

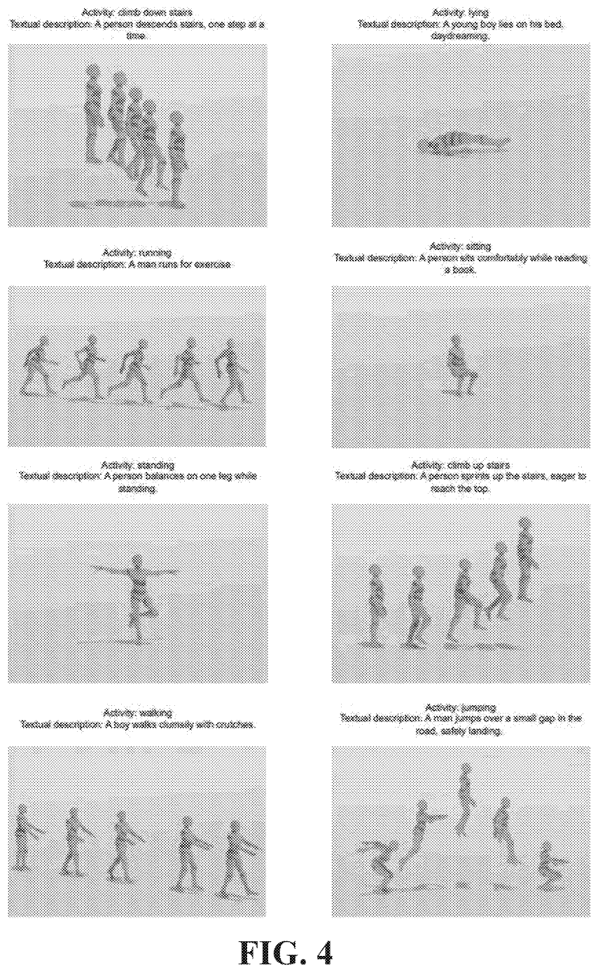

During inference 101a, the exemplary system 100a is configured to receive an activity description dataset 106 (e.g., HumanML3D dataset [20]) that includes a plurality of activity descriptions for the subject. The exemplary system 100a is then configured to generate, via the trained AI model 102, a set of motion sequences 108 (see FIG. 4) corresponding with the plurality of activity descriptions in the dataset 106. The exemplary system 100a is then configured to generate, via the motion-to-data conversion 104, a training dataset 110 using the set of motion sequences 108. The exemplary system 100a is then configured to output the training dataset 110, which can subsequently be used to train AI or ML models (e.g., Random Forest classifier, DeepConvLSTM [53]) to detect or recognize the activity of the subject. In some embodiments, the training dataset 110 includes a set of properties of each motion sequence in the set of motion sequences 108.

In FIG. 1B, the exemplary system 100b further includes a trained AI model 120 (shown as trained AI model #2) operatively coupled to the trained AI model 102. In some embodiments, the trained AI model 120 is a large language model (e.g., GPT-3 [11], GPT-4 [52], PaLM 2 [5], Llama 2 [68]) or a sentence transformer (e.g., Hugging Face).

During inference 101b, the exemplary system 100b is configured to receive a user input 122, such as the name of the activity (e.g., walk, run). The exemplary system 100b is then configured to generate, via the trained AI model 120, the activity description dataset 106 using the user input 122, which is then used by the trained AI model 102 to generate the set of motion sequences 108.

In FIGS. 1C and 1D, each exemplary system 100c and 100d further includes an iterative data-variability evaluation operation 130. In various implementations, using the iterative data-variability evaluation operation 130 can ensure that the training dataset 110 is optimized with respect to the amount and diversity of data generated for a particular training objective or task.

In FIG. 1C, the data-variability evaluation operation 130 is operatively coupled to the trained AI model 120. During inference 101c, the evaluation operation 130 is generally configured to (i) monitor a diversity of the descriptions in the dataset 106, and (ii) stop the trained AI model 120 from generating more descriptions in the dataset 106 when the diversity reaches a saturation point, because generating more descriptions no longer adds meaningful information to the dataset 106 and has no impact on the quality of the dataset 110.

Specifically, the evaluation operation 130 is configured to generate, in an iteration, embeddings (e.g., vector representations) for the activity description dataset 106, and each generated embedding includes semantic and syntactic data of a respective description (referred to as a data point) in the dataset 106. In some embodiments, the generated embeddings form one or more clusters in an embedding space. The evaluation operation 130 is then configured to determine, in the same iteration, a diversity score value (denoted as M_{std} or M_{cent}) (see Equations 2 and 4) that represents the variability among the generated embeddings. In some embodiments, the variability can be characterized by (i) distributions of the clusters and/or (ii) spatial distances (e.g., Euclidean distances) between centers of the clusters and the embeddings in those clusters.

The evaluation operation 130 is then configured to determine a difference (e.g., Maximum Mean Discrepancy (MMD)) (see Equation 5) between the determined diversity score value in the given iteration and a diversity score value in a previous iteration. When the determined difference exceeds a variability threshold among the generated embeddings (e.g., diversity has not reached the saturation point), the evaluation operation 130 is configured to generate, in subsequent iterations, more activity descriptions in the dataset 106 until a difference in diversity score values of two consecutive subsequent iterations fails to exceed the variability threshold (e.g., diversity has reached the saturation point). The variability threshold can be (i) predefined prior to the evaluation operation 130, or (ii) dynamically determined, during the evaluation operation 130, based on the convergence of diversity score values across previous iterations.

After the difference in diversity score values between the two consecutive subsequent iterations fails to exceed the variability threshold, the evaluation operation 130 is configured to transmit, to the trained AI model 120, a control signal 132 to stop the trained AI model 120 from generating additional descriptions in the dataset 106. The activity description dataset 106 is then used by the trained AI model 102 to generate the set of motion sequences 108.

In FIG. 1D, the data-variability evaluation operation 130 is operatively coupled to the trained AI model 102. During inference 100d, the evaluation operation 130 is generally configured to (i) monitor a diversity of motions in the set of motion sequences 108, and (ii) stop the trained AI model 102 from generating more motions in the set of motion sequences 108 when the diversity reaches a saturation point, because generating more motions no longer adds meaningful information to the set of motion sequences 108 and has no impact on the quality of the dataset 110.

Specifically, the evaluation operation 130 is configured to generate, in an iteration, embeddings for the set of motion sequences 108, and each generated embedding represents a respective motion in the set of motion sequences 108. In some embodiments, the generated embeddings form one or more clusters in an embedding space. The evaluation operation 130 is then configured to determine, in the same iteration, a diversity score value (e.g., M_{std} or M_{cent}) (see Equations 2 and 4) that represents the variability among the generated embeddings.

The evaluation operation 130 is then configured to determine a difference (e.g., MMD) (see Equation 5) between the determined diversity score value in the given iteration and a diversity score value in a previous iteration. When the determined difference exceeds a variability threshold among the generated embeddings (e.g., diversity has not reached the saturation point), the evaluation operation 130 is configured to generate, in subsequent iterations, more motions in the set of motion sequences 108 until a difference in diversity score values of two consecutive subsequent iterations fails to exceed the variability threshold (e.g., diversity has reached the saturation point). The variability threshold can be (i) predefined prior to the evaluation operation 130, or (ii) dynamically determined, during the evaluation operation 130, based on the convergence of diversity score values across previous iterations.

After the difference in diversity score values between the two consecutive subsequent iterations fails to exceed the variability threshold, the evaluation operation 130 is then configured to transmit, to the trained AI model 102, a control signal 132 to stop the trained AI model 102 from generating additional motions in the set of motion sequences 108. The set of motion sequences 108 is then used by the motion-to-data conversion operation 104 to generate the training dataset 110.

In FIG. 1E, the exemplary system 100d further includes a motion filtering operation 140 configured to remove (e.g., filter out) motions in the set of motion sequences 108 that are inconsistent with the activity description dataset 106. In some embodiments, the motion filtering operation 140, operatively coupled to the trained AI model 102, employs a trained AI model 142 (shown as trained AI model #3), which is a motion captioning model (e.g., MotionGPT [26]).

During inference 101e, the motion filtering operation 140 is configured to receive the set of motion sequences 108. The filtering operation 140 is then configured to encode, via the third trained AI model 142, the set of motion sequences 108 into a set of tokens (e.g., learnable motion codebook for a motion vocabulary), where each token represents a respective motion in the set of motion sequences 108. The filtering operation 140 is then configured to (i) generate, via the trained AI model 142, a set of motion descriptions 144 (e.g., motion captions) for the set of motion sequences 108 encoded in the set of tokens, and (ii) transmit the set of motion descriptions 144 to the trained AI model 120. The trained AI model 120 is then configured to (i) classify which motion descriptions in the set of motion descriptions 144 are inconsistent with the activity description dataset 106, and (ii) transmit classification results 146 to the filtering operation 140. The filtering operation 140 is then configured to remove (e.g., filter out) the motions in the set of motion sequences 108 associated with motion descriptions classified as inconsistent with the dataset 106, based on the classification results 146. The filtering operation 140 is then configured to transmit the filtered set of motion sequences 148 to the motion-to-data conversion 104 to generate the training dataset 110.

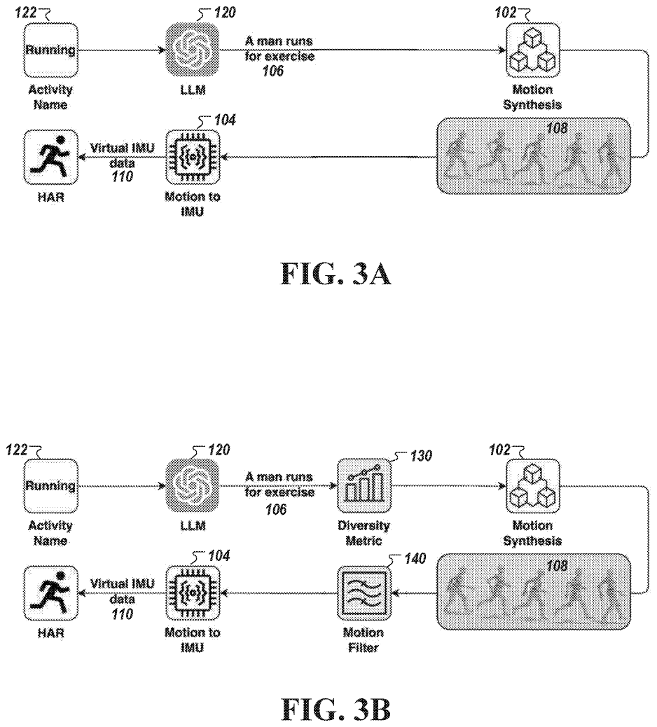

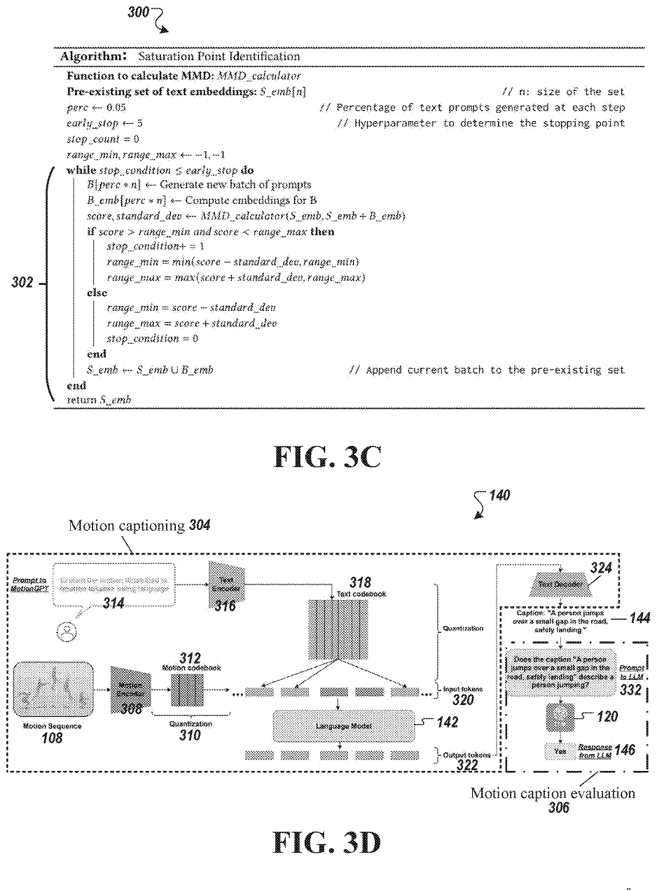

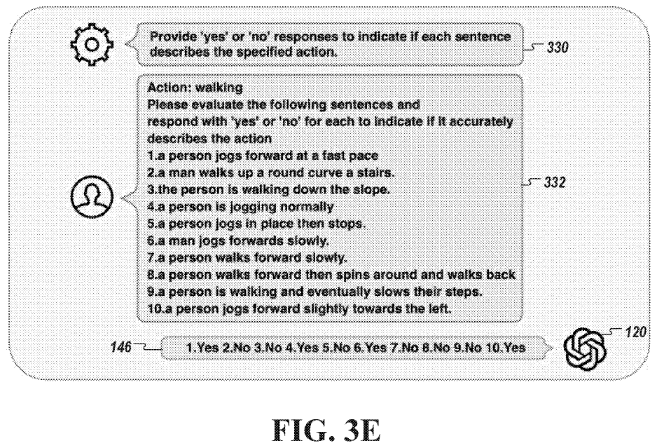

In some embodiments, to determine which motion descriptions in the set of motion descriptions 144 are inconsistent with the dataset 106, the motion filtering operation 104 is configured to label the motion descriptions in the set of motion descriptions 144 with binary classification values (see FIG. 3E), for example, (i) “yes” or “1” as consistent with the dataset 106 and (ii) “no” or “0” as inconsistent with the dataset 106. The motions associated with the motion descriptions labeled as “no” or “0” are subsequently removed (e.g., filtered out) from the set of motion sequences 108.

In some embodiments, the motion filtering operation 104 determines which motion descriptions in the set 144 are inconsistent with the dataset 106 based on one or more evaluation metrics, including similarity score values between the motion descriptions and the activity descriptions. For example, the motion filtering operation 104 is configured to classify motion descriptions in the set 144 (i) as consistent with the dataset 106 when the similarity score values are within a predefined range, or (ii) as inconsistent with the dataset 106 when the similarity score values are outside the predefined range. The motions associated with the motion descriptions labeled as inconsistent are subsequently removed (e.g., filtered out) from the set of motion sequences 108.

In some embodiments, the exemplary system 100 (e.g., 100a, 100b, 100c, 100d, 100e) is implemented on a mobile device (e.g., computer). In some embodiments, the exemplary system 100 (e.g., 100a, 100b, 100c, 100d, 100e) is implemented on a remote device located on a cloud infrastructure (e.g., Amazon Web Services, Google Cloud).

In some embodiments, the exemplary system 100 (e.g., 100a, 100b, 100c, 100d, 100e) is implemented in an agentic-AI pipeline operation having at least one trained AI model, such as the trained AI model 102, the trained AI model 120, and the trained AI model 140.

Training (103). In FIGS. 1A and 1C, each AI model 102 and 142 is trained by a training system 112. During inferences 103a or 103c, the training system 112 is configured to receive a dataset 114 (e.g., HumanML3D) comprising motion sequences acquired from a set of subjects (e.g., humans, animals), and a dataset 116 comprising descriptions of activities performed by the set of subjects. The training system 112 is then configured to train each AI model 102 (shown as 102′) and 142 (shown as 142′) using the motion sequences from the dataset 114 coupled with (e.g., labeled with) activity descriptions from the dataset 116.

In FIG. 1B, the AI model 120 (also shown as 120′) is trained by a self-supervised training system 124 (e.g., a training system without using labeled data). During training 103b, the trained system 124 is configured to (i) receive a dataset 126 (e.g., text corpora) comprising descriptions of activities performed by a set of subjects (e.g., humans, animals), and (ii) train the AI model 120 (also shown as 120′) using the dataset 126. In some embodiments, the dataset 126 comprises unlabeled data.

### Example Method

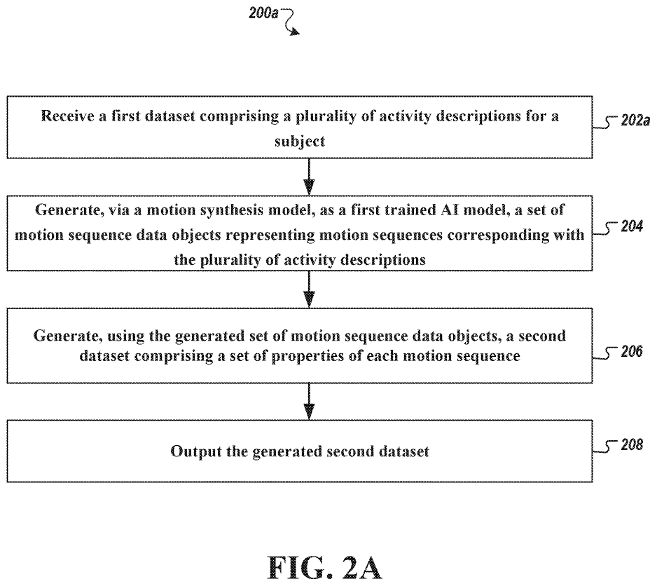

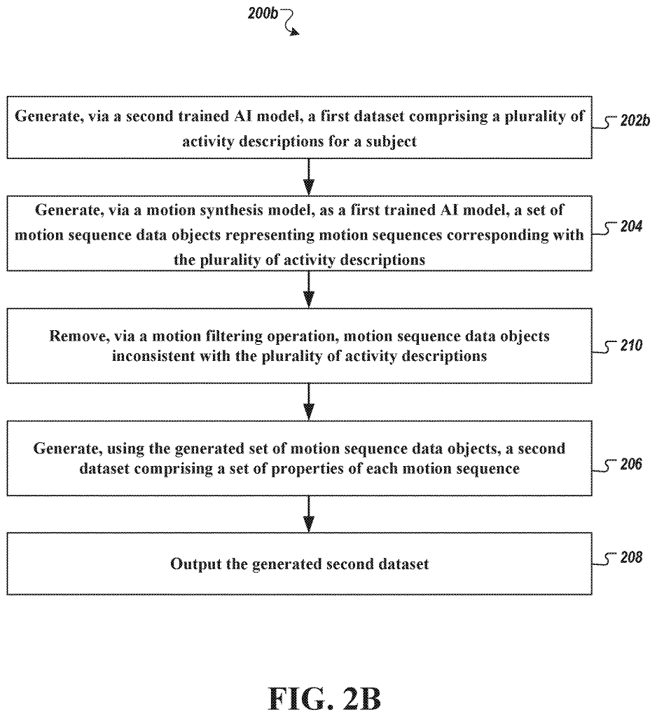

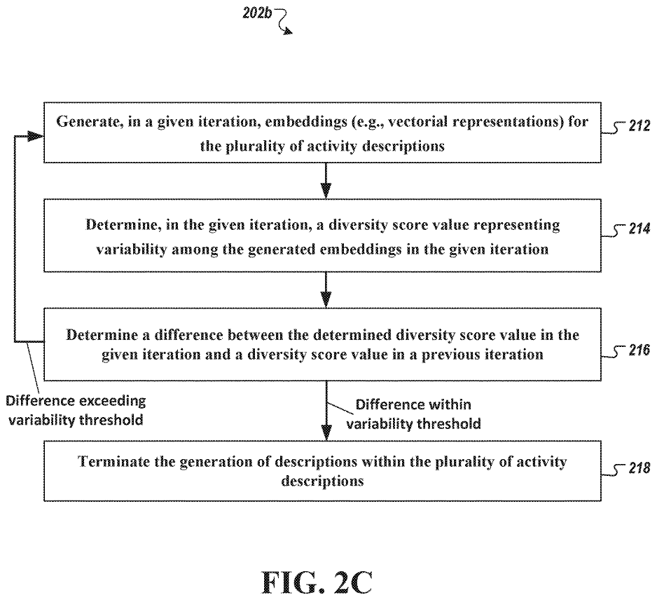

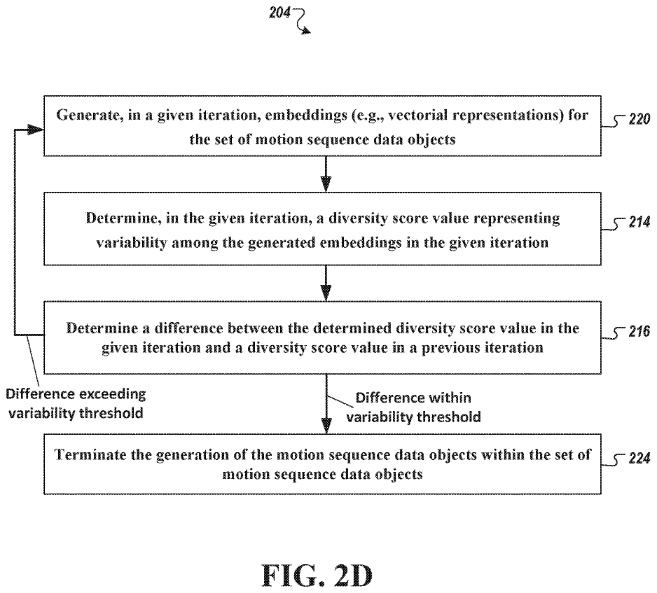

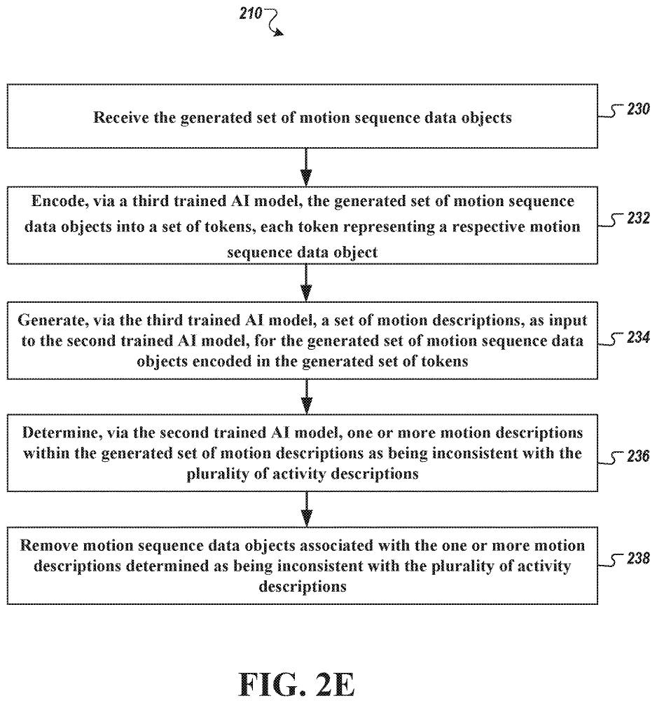

FIGS. 2A-2B each shows an example method (e.g., 200a, 200b) for operating the exemplary system, in accordance with an illustrative embodiment.

In FIG. 2A, at step 202a, the method 200a includes receiving a first dataset comprising a plurality of activity descriptions (e.g., 106) for a subject (e.g., human, animal). At step 204, the method 200a includes generating, via a motion synthesis model (e.g., 102), as a first trained AI model, a set of motion sequences (e.g., 108) corresponding to the plurality of activity descriptions (e.g., 106). At step 206, the method 200a includes generating (e.g., via a conversion operation 104), using the set of motion sequences (e.g., 108), a second dataset (e.g., 110) comprising a set of properties for each motion sequence. At step 208, the method 200a includes outputting the second dataset (e.g., 110) for subsequent use in training AI or ML models to detect or recognize the activity of the subject.

In some embodiments, the second dataset (e.g., 110) includes synthetic sensor measurements (e.g., virtual IMU data) associated with the motion sequences (e.g., 108).

In some embodiments, the motion synthesis model (e.g., 102) is a neural network trained using a dataset (e.g., HumanML3D) comprising motion sequences (e.g., 114) acquired from a set of subjects and coupled with corresponding descriptions (e.g., 116) of activities performed by the set of subjects.

In FIG. 2B, the method 200b further includes step 202b and step 210. At step 202b, the method 200b includes generating, via a second trained AI model (e.g., 120) (e.g., LLM, Sentence Transformer), the first dataset comprising the plurality of activity descriptions (e.g., 106), based on a user input (e.g., 122) that can be the name or type of the activity of the subject. At step 210, the method 200b includes removing (e.g., filtering out), via a motion filtering operation (e.g., 140), motions in the set of motion sequences (e.g., 108) that are inconsistent with the plurality of activity descriptions (e.g., 106). In some embodiments, the second trained AI model (e.g., 120) is a large language model (LLM) trained using a dataset (e.g., 126) (e.g., text corpora) comprising descriptions of activities performed by a set of subjects (e.g., humans, animals).

FIG. 2C shows an example iterative data-variability evaluation method 202b for the generation of the plurality of activity descriptions (e.g., 106) described in FIG. 2B. At step 212, the method 202b includes generating, in a given iteration, embeddings (e.g., vectorial representations) for the plurality of activity descriptions (e.g., 106). In some embodiments, each embedding includes semantic and syntactic data of a respective activity description, and the embeddings form one or more clusters (e.g., vectorial clusters) in an embedding space.

At step 214, the method 202b includes determining, in the given iteration, a diversity score value (denoted as M_{std} or M_{cent}) (see Equations 2 and 4) that represents the variability among the generated embeddings. In some embodiments, the variability is characterized by (i) distributions of the clusters and/or (ii) spatial distances (e.g., Euclidean distances) between centers of the clusters and the embeddings in those clusters.

At step 216, the method 202b includes determining a difference (e.g., MMD) (see Equation 5) between the determined diversity score value in the given iteration and a diversity score value in a previous iteration. When the determined difference exceeds a variability threshold among the generated embeddings, the method 202b returns to step 212, where the method 202b includes generating, in a subsequent iteration, additional activity descriptions and their corresponding embeddings. When the determined difference fails to exceed the variability threshold, at step 218, the method 202b includes terminating the generation of activity descriptions.

In some embodiments, the variability threshold is (i) predefined prior to the method 202b, or (ii) dynamically determined, during the method 202b, based on the convergence of diversity score values across previous iterations.

FIG. 2D shows an example iterative data-variability evaluation method 204 for the generation of the plurality of activity descriptions (e.g., 106) described in FIGS. 2A-2B. At step 220, the method 204 includes generating, in a given iteration, embeddings (e.g., vectorial representations) for the set of motion sequences (e.g., 108). In some embodiments, each generated embedding represents a respective motion in the set of motion sequences (e.g., 108), and the generated embeddings form one or more clusters (e.g., vectorial clusters) in an embedding space.

At step 214, the method 204 includes determining, in the given iteration, a diversity score value (denoted as M_{std} or M_{cent}) (see Equations 2 and 4) that represents the variability among the generated embeddings. At step 216, the method 204 includes determining a difference (e.g., MMD) (see Equation 5) between the determined diversity score value in the given iteration and a diversity score value in a previous iteration. When the determined difference exceeds a variability threshold among the generated embeddings, the method 204 returns to step 220, where the method 204 includes generating, in a subsequent iteration, additional motions and their corresponding embeddings. When the determined difference fails to exceed the variability threshold, at step 224, the method 204 includes terminating the generation of motions within the set of motion sequences (e.g., 108).

In some embodiments, the variability threshold is (i) predefined prior to the method 204, or (ii) dynamically determined, during the method 204, based on the convergence of diversity score values across previous iterations.

FIG. 2E shows an example method 210 for the motion filtering operation described in FIG. 2B. At step 230, the method 210 includes receiving the set of motion sequences (e.g., 108). At step 232, the method 230 includes encoding, via a third trained AI model (e.g., 142) (e.g., motion captioning model, MotionGPT), the set of motion sequences (e.g., 108) into a set of tokens (e.g., learnable motion codebook for a motion vocabulary), in which each token represents a respective motion. At step 234, the method 210 includes generating, via the third trained AI model, a set of motion descriptions (e.g., 144) (e.g., motion captions), as input to the second trained AI model (e.g., 120), for the set of motion sequences (e.g., 108) encoded in the set of tokens.

At step 236, the method 210 includes determining, via the second trained AI model (e.g., 120), one or more motion descriptions within the set of motion descriptions (e.g., 144) as being inconsistent with the first dataset of activity descriptions (e.g., 106). At step 238, the method 210 includes removing motions associated with the one or more motion descriptions determined as being inconsistent with the plurality of activity descriptions (e.g., 106).

In some embodiments, to determine which motion descriptions in the set of motion descriptions 144 are inconsistent with the dataset 106, the method 210 includes labeling the motion descriptions in the set of motion descriptions (e.g., 144) with binary classification values, for example, (i) “yes” or “1” as consistent with the dataset 106 and (ii) “no” or “0” as inconsistent with the dataset 106. The motions associated with the motion descriptions labeled as “no” or “0” are subsequently removed from the set of motion sequences (e.g., 108).

In some embodiments, the method 210 determines which motion descriptions are inconsistent with the plurality of activity descriptions (e.g., 106) based on one or more evaluation metrics, including similarity score values between the motion descriptions and the activity descriptions. For example, the method 210 includes classifying motion descriptions in the set of motion descriptions (e.g., 144) (i) as consistent with the plurality of activity descriptions (e.g., 106) when the similarity score values are within a predefined range, or (ii) as inconsistent with the plurality of activity descriptions (e.g., 106) when the similarity score values are outside the predefined range. The motions associated with the motion descriptions labeled as inconsistent are subsequently removed from the set of motion sequences (e.g., 108).

In some embodiments, the third trained AI model (e.g., 142) is trained using a language dataset (e.g., 116) coupled with motion sequences (e.g., 114) acquired from a set of people.

### Example Implementation

FIG. 3A shows an example implementation 300a of the exemplary system (see FIG. 1B), in accordance with an illustrative embodiment. As shown, the exemplary system is configured to generate virtual inertia measurement unit (IMU) data 110 from textual descriptions of activities 106 using a combination of a large language model (LLM) 120, a motion synthesis model 102, and a motion-to-data conversion operation 104, eliminating the need to search for videos and motion capture datasets. This disclosure contemplates that alternative methods can be used to generate textual descriptions of activities 106, including template-based inputs, algorithm-based generation techniques, retrieval operations from existing data sets, combinations thereof, and/or the like.

In FIG. 3A, the exemplary system (i) generates, via the LLM 120, textual descriptions 106 of relevant activities, and then (ii) converts, via the motion synthesis model 102, the descriptions into sequences of three-dimensional (3D) human motions 108. The motion-to-data conversion operation 104 (e.g., the IMUTube backend [33]) then generates virtual IMU data 110 from the motion sequences 108, which can subsequently be used to train human activity recognition (HAR) models. Table 1 shows example implementations of the LLM 120, the motion synthesis model 102, and the motion-to-data conversion operation 104.

TABLE 1

| | |
|---|---|
| Large language model 120 | The LLM 120 is configured to generate diverse textual |
| | descriptions 106 of a person performing a specified activity 122. |
| | In some embodiments, each LLM 120 is selected from the group |
| | comprising/consisting of GPT-3 [11], GPT-4 [52], PaLM 2 [5], |
| | and LLama 2 [68], each configured for natural language |
| | processing (NLP) tasks. |
| | Human activities are diverse, as the same activity can be |
| | performed in different ways by different people (e.g., a skinny |
| | teenager vs. a muscular athlete) and in different contexts (e.g., |
| | happily vs. sadly). To develop robust, generalizable HAR models, |
| | their training dataset should encompass a broad range of variations |
| | in human activities and contexts. Generating diverse textual |
| | descriptions 106 of activity 122 is a first step toward ensuring that |
| | the generated virtual IMU data 110 reflects real-world diversity. |
| | Additionally, using the LLM 120 for text generation can automate, |
| | simplify, or eliminate the process of gathering video data in video- |
| | based cross-modality transfer methods. |
| Motion synthesis model 102 | The motion synthesis model 102 is configured to receive textual |
| | descriptions 106 of the activity and convert them into 3D human |
| | motion sequences. The motion synthesis model 102 can bridge the |
| | gap between text and human motion. With the development of the |
| | HumanML3D dataset [20], a 3D human motion dataset with text |
| | descriptions, the motion synthesis model 102, such as MotionGPT |
| | [26], T2M-GPT [79], MotionDiffuse [80], and ReMoDiffuse [81], |
| | can generate more realistic human motion sequences 108 using |
| | textual descriptions 106 as the input. |
| Motion-to-data conversion | The motion-to-data conversion operation 104 is configured to |
| operation 104 | convert generated motion sequences into virtual IMU data, either |
| (e.g., motion-to-IMU operation) | biomechanically [78] or through neural networks [40], [61]. This |
| | is because the virtual IMU data extracted from the motion |
| | sequences can be used to train an HAR model, either alone or in |
| | conjunction with real IMU data. |

FIG. 3B shows an example implementation 300b of the exemplary system (see FIG. 1E), in accordance with an illustrative embodiment. As shown, the exemplary system further includes (i) a data-variability evaluation operation 130 (also referred to as a diversity metric operation) configured to determine the amount of virtual inertial measurement unit (IMU) data 110 to generate and (ii) a motion filtering operation 140 configured to assess the relevance of the generated virtual IMU data 110 for downstream human activity recognition (HAR) tasks. Table 2 shows example implementations of the data-variability evaluation operation 130 and the motion filtering operation 140.

TABLE 2

| | |
|---|---|
| Data-variability evaluation | The data-variability evaluation operation 130 is configured to |
| operation 130 | measure the diversity of textual descriptions 106 and motion |
| | sequences 108 generated by the LLM 120 and motion synthesis |
| | model 102, respectively. HAR model performance (also referred |
| | to as downstream performance) can depend on the diversity of the |
| | virtual IMU data 110, as more diverse data can improve |
| | performance. In some embodiments, the data-variability |
| | evaluation operation 130 employs a saturation-point identification |
| | algorithm (see FIG. 3C) to identify the point at which generating |
| | additional textual descriptions no longer adds meaningful |
| | information to the existing pool of generated texts 106. This point |
| | indicates a stopping point for text generation. Identifying when to |
| | stop data generation can save time and computing resources. |
| Motion filtering operation 140 | The motion filtering operation 140 is a pipeline configured to |
| | identify and filter out motion sequences that do not depict the |
| | specified activity. The motion synthesis model 102 may not |
| | always generate motion sequences 108 that depict a person |
| | performing the specified activity 122, as the motion synthesis |
| | model 102 can confuse closely related activities (e.g., climbing |
| | upstairs vs. climbing downstairs), leading to irrelevant motion |
| | sequences. Irrelevant motion sequences can negatively impact the |
| | downstream performance by introducing noise. |

### Example Data—Variability Evaluation Operation (e.g., 130)

A limitation of the implementation shown in FIG. 3A is the lack of an indication of when data generation (e.g., 202b, 204) should be stopped. Establishing an explicit stopping point for data generation (e.g., 202b, 204) can (i) provide controlled management of computational and temporal resources during generation and (ii) ensure that the generated data (e.g., 106, 108) contribute to the HAR modeling task, facilitating the implementation of the exemplary system. For this reason, the diversity of the generated data (e.g., 106, 108) can be used to determine the stopping point. The diversity of the virtual IMU data (e.g., 110) can be measured through the textual descriptions (e.g., 106) or the motion sequences (e.g., 108) from which it is generated. Because the motion sequences (e.g., 108) can be obtained from the textual descriptions (e.g., 106), the diversity should be correlated. Calculating the diversity of textual descriptions (e.g., 106) can be more practical, as the textual descriptions generation step (e.g., 202b) precedes the motion sequence generation step (e.g., 204), thereby saving computational costs.

Measuring diversity can quantify the amount of useful information in the data (e.g., 106, 108), which can then be used to evaluate the downstream performance. When diversity is high, HAR models can be exposed to a broader range of data points during subsequent training, leading the HAR models to learn to make predictions across a wider range of cases and thereby improving their performance. Diverse training data (e.g., 110) also helps prevent HAR models from overfitting, since a limited dataset can lead to overexposure to a small portion of the feature space. Having practical measures that facilitate estimating the downstream performance at the time of generation (e.g., 202b, 204) can be helpful, provided diversity is computationally inexpensive to calculate.

To calculate the diversity of data, using textual descriptions (e.g., 106) or motion sequences (e.g., 108), embeddings for the data should be generated. Embeddings are vector representations of data that can capture semantic and syntactic information. Each data point in the data (e.g., 106, 108) can be mapped to a vector in an embedding space. Because vector operations can be applied to data in an embedding format, they can provide a representation (e.g., a diversity metric) for evaluating data variability. Table 3 shows example generation operations for embeddings of textual descriptions or motion sequences.

TABLE 3

| Embedding(s) | Generation operation |
|---|---|
| For textual description(s) | The text prompts (e.g., 106) are passed through a Sentence Transformer |
| (e.g., 106) | (e.g., all-mpnet-base-v2 model [1], [57]) to generate embeddings for each |
| | prompt. The Sentence Transformer can be trained on 1 billion sentence |
| | pairs to capture semantic information in its input text, and thus the |
| | generated embeddings can serve as a representation of the sentence. |
| For motion sequence(s) | Each motion sequence (e.g., 108) is passed through a model trained on the |
| (e.g., 108) | HumanML3D dataset [20] to generate the embeddings for the sequence. |
| | This model can be drawn from the motion feature extractor trained in Guo |
| | et al. [20] and is commonly used [79]. |

Two types of diversity can be determined: (i) absolute diversity, and (ii) comparative diversity. An absolute diversity metric and a comparative diversity metric can be applicable to any set of embeddings, irrespective of whether the embeddings are generated from textual descriptions (e.g., 106) or motion sequences (e.g., 108). Absolute diversity can provide a quantitative measure of the amount of diverse information contained in a set, while comparative diversity can determine how much two sets differ in their diversity.

Absolute Diversity Metric. There are two types of absolute diversity metric: a standard deviation metric and a centroid metric [16]. For both metrics, a higher value corresponds to a more diverse set, and vice versa. Table 4 shows example deviation and centroid metrics of a set of embeddings.

TABLE 4

| Metric | Description |
|---|---|
| Standard | The standard deviation metric is based on the diversity metric in Lai et al. [36]. |
| deviation metric | Interpreting embeddings as vectors in a high-dimensional embedding space, the |
| | dispersion (the “spread”) of a cluster of such vectors should be characterized. If the |
| | cluster is distributed as a multivariate Gaussian, each isocontour can be shaped as |
| | an axis-aligned ellipsoid. The radii of the ellipsoid along each axis can be |
| | computed by calculating the standard deviation of the vectors in the cluster along |
| | each of the axes. Thus, computing the geometric mean of the radii can capture the |
| | generalized radius of the cluster, providing a metric for the diversity. When the set |
| | of embeddings (denoted as S) includes n embedding vectors, each with dimension |
| | $k , the set can be formalized as S = {\{ {x}_{i} \}}_{i = 1}^{n} ⊂ {R}^{k} . Thus , the standard deviation$ |
| | along an axis j ∈ [1, k] can be computed per Equation 1. |
| | ${σ}_{j} = \sqrt{\frac{{\sum }_{i = 1}^{n} {( {x}_{i}^{j} - {μ}^{j} )}^{2}}{n}} , where {μ}^{j} = \frac{{\sum }_{i = 1}^{n} {x}_{i}^{j}}{n} \qquad ( Eq . 1 )$ |
| | The standard deviation diversity score (denoted as M_{std}) can then be calculated per |
| | Equation 2. |
| | ${M}_{std} = {( {\prod }_{j = 1}^{k} {σ}_{j} )}^{\frac{1}{k}} \qquad ( Eq . 2 )$ |
| Centroid metric | When the set of embeddings S includes n embedding vectors, each with dimension |
| | $k , the set can be formalized as S = {\{ {x}_{i} \}}_{i = 1}^{n} ⊂ {R}^{k} . First , the centroid vector ( denoted$ |
| | as X_{cent}) of all embedding vectors can be calculated per Equation 3. |
| | ${x}_{cent} = \frac{{\sum }_{i = 1}^{n} {x}_{i}}{n} \qquad ( Eq . 3 )$ |
| | The centroid diversity score (denoted as M_{cent}) can then be computed, per Equation |
| | 4, as the mean of the sum-squared distances of all embedding vectors from the |
| | centroid vector. |
| | ${M}_{cent} = \frac{{\sum }_{i = 1}^{n} {( d ( {x}_{i} , {x}_{cent} ) )}^{2}}{n} , where d ( {x}_{i} , {x}_{cent} ) = \sqrt{{\sum }_{j = 1}^{k} {( {x}_{i}^{j} - {x}_{cent}^{j} )}^{2}} \qquad ( Eq . 4 )$ |
| | In Equation 4, d is the Euclidean distance. The greater the diversity of a set of |
| | embeddings, the farther apart their vectors can be in the embedding space. As a |
| | result, the data points tend to be farther from the overall mean than in a less diverse |
| | set, which is quantified by the centroid metric. To quantify the dispersion of all the |
| | vectors in the embedding space, only a single centroid is utilized for the entire set |
| | of embeddings. |

Comparative Diversity Metric. The textual description generation process (e.g., 202b) can start by generating an initial set of descriptions. Then, newly generated batches of textual descriptions can be sequentially appended to the existing set of descriptions (e.g., 106). If incorporating a newly generated batch of textual descriptions increases the diversity of the pre-existing set (e.g., 106), then further generating new batches can improve the diversity of the virtual IMU data (e.g., 110), thereby improving HAR model performance. On the contrary, if diversity does not improve, then no further batches of textual descriptions should be generated. Comparative diversity can quantify the change in diversity when a new batch is added to an existing set.

The comparative diversity between two sets of embeddings can be computed using the Maximum Mean Discrepancy (MMD) test [19]. MMD is a kernel-based statistical test that indicates whether two given sets of samples are drawn from the same distribution. The higher the value, the farther apart the distributions of the two sets of samples. Given a space R^{d} and independent and identically distributed samples Xᵢ∈R^{d}, i=1, . . . , Nₓ sampled from X~P_{X} and Yᵢ∈R^{d}, i=1, . . . , N_{y} sampled from Y~P_{Y}, the MMD can quantify the difference between P_{X} and P_{Y}. MMD can be calculated per Equation 5.

$$MMD = {\sum }_{i = 1}^{{N}_{x}} {\sum }_{j = 1}^{{N}_{x}} K ( {X}_{i} , {X}_{j} ) + {\sum }_{i = 1}^{{N}_{y}} {\sum }_{j = 1}^{{N}_{y}} K ( {Y}_{i} , {Y}_{j} ) - 2 {\sum }_{i = 1}^{{N}_{x}} {\sum }_{j = 1}^{{N}_{y}} K ( {X}_{i} , {Y}_{j} ) \qquad ( Eq . 5 )$$

In Equation 5, K is the Gaussian kernel. Any two sets of embedding can be interpreted as being drawn from two distributions, and the distance between the two distributions can be calculated to serve as the difference in diversity. If the distributions of the two sets of embeddings are similar, they can have a similar diversity, and correspondingly, the MMD value for the pair of sets can be lower.

Saturation Point Identification. The comparative diversity metric can be used to stop the generation of textual descriptions (e.g., 202b) when the generated set of descriptions (e.g., 106) saturates (e.g., generating additional descriptions does not improve the diversity of the existing set). FIG. 3C shows an example saturation-point identification algorithm 300 used by the data-variability evaluation operation (e.g., 130) to determine the stopping point for the generation of textual descriptions (e.g., 202b).

In FIG. 3C, at block 302, given a set of textual descriptions S of size n, the algorithm 300 iteratively generates new batches of descriptions and tests if adding the new batch to the existing set S substantially alters the comparative diversity. The size of the new batch is a percentage of the size of the existing set S and is a tunable hyperparameter. Setting a higher value for the percentage (e.g., size of the new batch) can imply a coarser step towards the saturation point.

At block 302, if adding the new batch substantially alters the diversity, then the diversity has not saturated, and the algorithm 300 continues. On the other hand, if the diversity does not change, then the diversity is close to saturation, and the algorithm 300 terminates. The termination can be controlled via a hyperparameter (e.g., “early_stop”) that controls the tolerance for saturation.

For calculating the MMD between two sets of embeddings, the two sets should have the same size. However, at block 302, the MMD is calculated, via an “MMD_calculator” function, between two sets of different sizes (e.g., S_emb and S_emb U B_emb). To do so, the smaller set is randomly resampled until it matches the larger set in size, and then the MMD is calculated. The resampling is performed multiple times, yielding various MMD values; thus, the “MMD_calculator” function returns the mean score along with the MMD standard deviation.

### Example Motion Filtering Operation (e.g., 140)

Another limitation of the implementation shown in FIG. 3A is that the motion synthesis model (e.g., 102) can generate motion sequences (e.g., 108) that do not describe the intended activity (e.g., 122), leading to the extraction of irrelevant virtual IMU data (e.g., 110) and degrading the HAR model performance. To address this, the exemplary system can employ a motion filtering operation (e.g., 140) that can filter out incorrectly generated motion.

FIG. 3D shows an example motion filtering operation 140, in accordance with an illustrative embodiment. As shown, the motion filtering operation 140 includes a motion captioning operation 304 and a motion caption evaluation operation 306. As shown, to determine if a given motion sequence 108 portrays the activity of interest, the sequence generated by the motion synthesis model (e.g., 102) is first processed, in the motion captioning operation 304, by a motion captioning model 142 (e.g., TM2T [21], MotionGPT [26]) that outputs a textual description 144 of the motion sequence 108. The resulting motion caption 144 is then evaluated, in the motion caption evaluation operation 306, by the LLM 120 that provides a binary “yes” or “no” answer 146 indicating whether the caption 144 describes the specified activity (e.g., 122). The binary answer 146 from the LLM 120 can filter out incorrectly generated motion sequences.

Motion Captioning (304). In FIG. 3D, the motion captioning operation 304, e.g., the motion-to-text operation, can generate a text description 144 of a given human motion sequence 108. The motion captioning operation 304 can use MotionGPT, as the motion captioning model 142, to caption the generated motion sequences 108. MotionGPT is a motion-language model trained on language data and motion data to handle motion-relevant tasks, such as text-driven motion synthesis, motion captioning, motion prediction, and motion in-between.

To caption a given input motion sequence of length-M frames

$${m}^{1 : M} = {\{ {x}_{i} \}}_{i = 1}^{M} ,$$

the motion sequence 108 is encoded into L discrete motion tokens, denoted as V^{1:L}, using a motion encoder 308 (denoted as ε), as shown in Equation 6. In Equation 6, l is the temporal downsampling rate with respect to the motion length.

$${v}^{1 : L} = ε ( {m}^{1 : M} ) = {\{ {v}_{i} \}}_{i = 1}^{L} , where L = M / l \qquad ( Eq . 6 )$$

The motion encoder 308 is a motion tokenizer based on the Vector Quantized Variational Autoencoder (VQ-VAE) [70], which represents the motion sequences 108 as language. The motion encoder 308 can include one-dimensional (1D) convolution and quantization. In the one-dimensional (1D) convolution, convolution layers can be applied to the motion sequence m^{1:M} (shown as 108) along the time dimension to generate the latent vectors \hat{v}^{1:L} The latent vectors can then be converted, via a discrete quantization 310, into code indices in a learnable motion codebook 312 with Kₘ latent embedding vectors of dimension d, denoted as

$${V}_{m} = {\{ {v}_{m}^{i} \}}_{i = 1}^{{K}_{m}} .$$

During the quantization 310, each latent vector can be replaced with the nearest vector in V, which can minimize the Euclidean distance per Equation 7.

$${v}^{i} = arg {min}_{{v}^{k} ∈ V} {‖ {\hat{v}}^{i} - {v}^{k} ‖}_{2} \qquad ( Eq . 7 )$$

In Equation 6, vⁱ is the quantized latent vector. The code indices corresponding to the quantized latent vectors in the motion codebook 312 are motion tokens, which can be interpreted as the vocabulary for human motion.

In addition to receiving the motion sequence 108 as input, the motion captioning model 142 (e.g., MotionGPT) can also receive a textual prompt 314 describing the specific task to be performed, e.g., motion captioning. Similar to the input motion sequence 108, the input textual prompt 314 is encoded (e.g., tokenized), using a text encoder 316 (e.g., of a text tokenizer, SentencePiece [30]), into a text codebook 318 with a vocabulary of Kₜ text tokens, denoted as

$${V}_{t} = {\{ {v}_{t}^{i} \}}_{i = 1}^{{K}_{t}} .$$

The text codebook 318 is then combined with the motion codebook 312 that has motion tokens and special tokens (e.g., tokens indicating the start and end of the motion sequence 108) to form the unified vocabulary 320, denoted as V={Vₜ, Vₘ}, of the motion captioning model 142. The tokens/words in the unified vocabulary can represent text, human motion, or a mixture of the two, enabling the motion captioning model 142 (e.g., MotionGPT) to use text and motion as inputs 320 and outputs 322 to complete a range of motion-related tasks.

The sequence of text and motion tokens (shown as 320), denoted as

$$Xs = {\{ {x}_{S}^{i} \}}_{i = 1}^{N} ,$$

xₛ∈V, are then passed to the motion captioning model 142 as input. The motion captioning model 142 generates a sequence of output tokens 322, denoted as

$${X}_{t} = {\{ {x}_{t}^{i} \}}_{i = 1}^{L} ,$$

in an autoregressive manner. The motion captioning model 142 can be trained using the loss function as shown in Equation 8.

$${L}_{LM} = - {\sum }_{i = 0}^{{L}_{t} - 1} log {p}_{θ} ( {x}_{t}^{i} \vert {x}_{t}^{0} , … , {x}_{t}^{i - 1} , {x}_{s} ) \qquad ( Eq . 8 )$$

The sequence of output tokens 322 is then decoded using a text decoder 324 to retrieve the output texts 144 (e.g., motion caption).

In some embodiments, the codebook size of the motion encoder 308 is set to V∈R^{512×512}. Additionally, the motion encoder 308 uses a temporal downsampling rate of 4. T5 [55] can be chosen as the motion captioning model 142 with 12 layers in both the encoder and decoder. The motion captioning model 142 can be trained on the HumanML3D dataset [20], which contains large amounts of human motion capture data along with corresponding textual descriptions, using the AdamW optimizer. The pre-trained model in Jiang et al. [26] can also be used for the motion captioning operation 304.

Motion Caption Evaluation (306). In FIG. 3D, the evaluation operation 306 is configured as a binary classification in which the input is (i) a textual description (denoted as m), the motion caption 144 of a human motion sequence 108, and (ii) a specific activity of interest (e.g., 122) (denoted as a). The output 146 is a binary label (denoted as y∈{0, 1}) indicating whether the input textual description 144 depicts a person performing the activity of interest (e.g., 122). Let M denote the space of all possible textual motion captions 144, and let A denote the set of all predefined activities of interest. The exemplary system can learn a function ƒ that maps a pair (motion caption, activity) to the binary label, as shown in Equation 9.

$$f : M \times A \to \{ 0 , 1 \} \qquad ( Eq . 9 )$$

In Equation 9, the function ƒ determines whether a given motion caption m∈M describes a person performing a given activity a∈A. In supervised NLP methods, learning the function ƒ can require large amounts of training data containing motion captions for specific activities. Collecting such a large training dataset can be time-consuming and infeasible.

Hence, the exemplary system uses the LLM 120 for the evaluation operation 306, as it is configured for zero-shot NLP tasks [11], [28]. The LLM 120 may have learned the function ƒ during training from the training corpus in previous studies, as it can understand the correspondence between motion descriptions and activities.

To obtain the labels from the LLM 120, a task is assigned to them via a message 330 (see FIG. 3E) that defines their role. In the message 330, the LLM 120 is asked to provide binary “yes” or “no” labels, indicating whether the motion captions 144 describe the specified activity. The message 330 can help LLM 120 understand their roles and reduce post-processing effort. Without the message 330, the LLM 120 can produce miscellaneous texts unrelated to the evaluation. After setting up the message 330, the specified activity name and a list of motion captions are provided, via a prompt 332, to the LLM 120. The LLM 120 then outputs “yes” or “no” labels 146 for each caption. A “yes” label indicates that the caption describes someone performing the specified activity, and a “no” label indicates otherwise. The binary labels 146 from the LLM 120 can be used to filter out incorrectly generated motion sequences.

This approach is a zero-shot task for the LLM 120, as no example captions and labels are provided for the LLM 120 to learn from. FIG. 3E shows the message 330, motion captions in the prompt 332, and binary labels 146 generated by the LLM 120 (e.g., GPT-4 [52]), in accordance with an illustrative embodiment. The LLM 120 can be fallible, as shown in FIG. 3E, incorrectly labeling the caption “a person jogs in place then stops” as “no” for the running activity.

### Example Artificial Intelligence (AI) and Machine Learning (ML) Models

Machine Learning. In addition to the machine learning features described above, the exemplary system can be implemented using one or more artificial intelligence and machine learning operations. The term “artificial intelligence” can include any technique that enables one or more computing devices or computing systems (i.e., a machine) to mimic human intelligence. Artificial intelligence (AI) includes but is not limited to knowledge bases, machine learning, representation learning, and deep learning. The term “machine learning” is defined herein to be a subset of AI that enables a machine to acquire knowledge by extracting patterns from raw data. Machine learning techniques include, but are not limited to, logistic regression, support vector machines (SVMs), decision trees, Naïve Bayes classifiers, and artificial neural networks. The term “representation learning” is defined herein to be a subset of machine learning that enables a machine to automatically discover representations needed for feature detection, prediction, or classification from raw data. Representation learning techniques include, but are not limited to, autoencoders and embeddings. The term “deep learning” is defined herein to be a subset of machine learning that enables a machine to automatically discover representations needed for feature detection, prediction, classification, etc., using layers of processing. Deep learning techniques include, but are not limited to, artificial neural networks or multilayer perceptron (MLP).

An artificial neural network (ANN) is a computing system including a plurality of interconnected neurons (e.g., also referred to as “nodes”). This disclosure contemplates that the nodes can be implemented using a computing device (e.g., a processing unit and memory as described herein). The nodes can be arranged in a plurality of layers, such as an input layer, an output layer, and optionally one or more hidden layers with different activation functions. An ANN having hidden layers can be referred to as a deep neural network or multilayer perceptron (MLP). Each node is connected to one or more other nodes in the ANN. For example, each layer is made of a plurality of nodes, where each node is connected to all nodes in the previous layer. The nodes in a given layer are not interconnected with one another, i.e., the nodes in a given layer function independently of one another. As used herein, nodes in the input layer receive data from outside of the ANN, nodes in the hidden layer(s) modify the data between the input and output layers, and nodes in the output layer provide the results. Each node is configured to receive an input, implement an activation function (e.g., binary step, linear, sigmoid, tanh, or rectified linear unit (ReLU) function), and provide an output in accordance with the activation function. Additionally, each node is associated with a respective weight. ANNs are trained with a dataset to maximize or minimize an objective function. In some implementations, the objective function is a cost function, which is a measure of the ANN's performance (e.g., error such as L1 or L2 loss) during training, and the training algorithm tunes the node weights and/or bias to minimize the cost function. This disclosure contemplates that any algorithm that finds the maximum or minimum of the objective function can be used for training the ANN. Training algorithms for ANNs include, but are not limited to, backpropagation. It should be understood that an artificial neural network is provided only as an example machine learning model. This disclosure contemplates that the machine learning model can be any supervised learning model, semi-supervised learning model, or unsupervised learning model. Optionally, the machine learning model is a deep learning model. Machine learning models are known in the art and are therefore not described in further detail herein.

A convolutional neural network (CNN) is a type of deep neural network that has been applied, for example, to image analysis applications. Unlike traditional neural networks, each layer in a CNN has a plurality of nodes arranged in three dimensions (width, height, depth). CNNs can include different types of layers, e.g., convolutional, pooling, and fully-connected (also referred to herein as “dense”) layers. A convolutional layer includes a set of filters and performs the bulk of the computations. A pooling layer is optionally inserted between convolutional layers to reduce the computational power and/or control overfitting (e.g., by downsampling). A fully-connected layer includes neurons, where each neuron is connected to all of the neurons in the previous layer. The layers are stacked similarly to traditional neural networks. GCNNs are CNNs that have been adapted to work on structured datasets such as graphs.

Large Language Models (LLMs) are models that are configured to generate human-readable textual data based on received inputs. Such models can be used to answer questions, summarize text, generate novel content, or independently converse with users. An example LLM can be trained on large volumes of textual data and utilizes deep learning to generate natural language outputs.

Other Supervised Learning Models. A logistic regression (LR) classifier is a supervised classification model that uses the logistic function to predict the probability of a target, which can be used for classification. LR classifiers are trained with a data set (also referred to herein as a “dataset”) to maximize or minimize an objective function, for example, a measure of the LR classifier's performance (e.g., an error such as L1 or L2 loss), during training. This disclosure contemplates that any algorithm that finds the minimum of the cost function can be used. LR classifiers are known in the art and are therefore not described in further detail herein.

A Naïve Bayes' (NB) classifier is a supervised classification model that is based on Bayes' Theorem, which assumes independence among features (i.e., the presence of one feature in a class is unrelated to the presence of any other features). NB classifiers are trained with a data set by computing the conditional probability distribution of each feature given a label and applying Bayes' Theorem to compute the conditional probability distribution of a label given an observation. NB classifiers are known in the art and are therefore not described in further detail herein.

A k-NN classifier is an unsupervised classification model that classifies new data points based on similarity measures (e.g., distance functions). The k-NN classifiers are trained with a data set (also referred to herein as a “dataset”) to maximize or minimize a measure of the k-NN classifier's performance during training. This disclosure contemplates any algorithm that finds the maximum or minimum. The k-NN classifiers are known in the art and are therefore not described in further detail herein.

A majority voting ensemble is a meta-classifier that combines a plurality of machine learning classifiers for classification via majority voting. In other words, the majority voting ensemble's final prediction (e.g., class label) is the one predicted most frequently by the member classification models. The majority voting ensembles are known in the art and are therefore not described in further detail herein.

### EXPERIMENTAL RESULTS AND ADDITIONAL EXAMPLES

A study was conducted to develop and evaluate two experimental systems, namely the first and second experimental systems, each comprising a large language model (e.g., 120), a motion synthesis model (e.g., 102), and a motion-to-data conversion operation (e.g., 104), as described in relation to FIGS. 1-3. The second experimental system further included a data-variability evaluation operation (e.g., 130) and a motion filtering operation (e.g., 140).

The study conducted a large-scale evaluation of the experimental systems, focusing on the practical aspects of the language-based cross-modality transfer approach and assessing its relevance for real-world HAR applications. The study first evaluated the first experimental system, where the study used (i) five LLMs, such as GPT-3.5 [2], GPT-4 [52], Palm 2 (Bard) [5], Gemini [67], and LLaMa 2 [68], to generate textual descriptions, and (ii) four motion synthesis models, such as T2M-GPT [79], MotionGPT [26], MotionDiffuse [80], and ReMoDiffuse [81], to generate motion sequences. Through the evaluation, the study examined the impact of different LLM and motion synthesis models on HAR model performance (also referred to as downstream performance) and revealed their suitability, which could help design language-based cross-modality transfer systems.

The study also conducted an evaluation of the second experimental system that extended the evaluation of the first experimental system. In this evaluation, the study began with the data-variability evaluation operation, validated whether the diversity in the generated textual descriptions and motion sequences could predict the downstream performance, and evaluated the effectiveness of the saturation point identification algorithm. Following this, the study evaluated the motion filtering operation and determined how effectively it filtered out incorrectly generated motion sequences, as well as its impact on the HAR model performance.

### Human Activity Recognition (HAR) Models

The study evaluated five public HAR datasets: RealWorld [65], PAMAP2 [58], USC-HAD [82], HAD-AW [50], and MyoGym [29]. The five HAR datasets included IMU data recorded from varying on-body locations like head, chest, arm, waist, and leg for daily activities. Each HAR dataset covered different activities and a varying number of subjects.

The evaluation of the HAR datasets was based on three HAR models: a Random Forest classifier, a DeepConvLSTM [53], and a DeepConvLSTM with self-attention [64]. The study used 2-second-long sliding windows with a 50% overlap between consecutive frames to split the IMU data. The study trained the Random Forest classifier on ECDF features [22]. The study trained DeepConvLSTM and DeepConvLSTM with self-attention on IMU raw data for up to 30 epochs using an Adam optimizer and a ReduceLROnPlateau learning rate scheduler [3]. The study used grid search to determine the learning rate and weight decay. The learning rate varied from 10-6 to 10-2, and the weight decay varied from 10-4 to 10-3. For RealWorld, PAMAP2, USC-HAD, and MyoGym datasets, the study used leave-one-subject-out cross-validation for all 3 HAR models. For the HAD-AW dataset, the study used 5-fold stratified cross-validation, since not all subjects performed the full set of activities in the released dataset. For each HAR model, the study repeated cross-validation across 3 random seeds and reported the average macro F1 score and its standard deviation across the 3 runs.

### Impact of LLM on Textual Description Generation and HAR

The study examined five LLMs, such as GPT-3.5, GPT-4, Palm 2 (Bard), Gemini, and LLaMa 2, to assess their ability to generate textual descriptions of diverse human activities and their impact on HAR model performance.

Experimental Setting. The study generated motion descriptions using the five LLMs. All LLMs, except LLaMa 2, were available as APIs, while the LLaMa 2 model with 70 billion parameters was deployed and hosted on a server for use as an API. An automated pipeline was developed with parameters for the model type and the dataset. The study tested each LLM to determine the optimal prompt for generating text descriptions. The activities from all five HAR datasets were provided to the five LLMs as text, along with sample descriptions, and the five LLMs were asked to describe a person performing the activity.

The generation of 1,000 descriptions for each activity was performed in batches of 50, as larger batches led to errors. The resulting LLM responses were parsed to remove empty lines, serial numbers, and auxiliary text (e.g., “Here are the descriptions for the activity”). The cleaned descriptions were fed into the motion synthesis models to generate motion sequences, and the virtual IMU data were extracted using the first experimental system.

Results. Table 5 shows the downstream performance results (e.g., macro F1 scores) when the five LLMs were used to generate the textual descriptions in the first experimental system. “Real Data” denotes baseline experiments not including any generated, virtual IMU data.

TABLE 5

| | RealWorld | PAMAP2 | USC-HAD | HAD-AW | MyoGym |
|---|---|---|---|---|---|
| | Random Forest classifier | | | | |
| GPT-3.5 | 79.70 ± 0.38 | 69.20 ± 0.29 | 49.72 ± 0.67 | 48.98 ± 0.11 | 47.93 ± 0.58 |
| GPT-4 | 79.41 ± 0.29 | 67.73 ± 0.70 | 49.07 ± 0.27 | 48.61 ± 0.20 | 47.64 ± 0.17 |
| LLaMa 2 | 79.02 ± 1.01 | 67.82 ± 0.30 | 49.41 ± 0.28 | 48.40 ± 0.08 | 47.95 ± 0.25 |
| Palm 2 (Bard) | 78.79 ± 0.65 | 68.42 ± 0.43 | 49.06 ± 0.31 | 49.36 ± 0.05 | 47.91 ± 0.25 |
| Gemini | 78.93 ± 0.17 | 67.53 ± 0.10 | 49.65 ± 0.51 | 48.70 ± 0.06 | 47.98 ± 0.22 |
| Real Data | 71.53 ± 1.07 | 67.08 ± 0.53 | 47.23 ± 0.08 | 52.77 ± 0.07 | 46.61 ± 0.09 |
| | Deep ConvLSTM | | | | |
| GPT-3.5 | 82.25 ± 0.32 | 75.16 ± 0.82 | 61.44 ± 0.49 | 51.98 ± 0.28 | 49.46 ± 0.88 |
| GPT-4 | 80.20 ± 0.88 | 73.59 ± 0.75 | 61.43 ± 0.59 | 51.11 ± 0.28 | 46.85 ± 0.28 |
| LLaMa 2 | 82.33 ± 0.34 | 74.12 ± 0.88 | 60.93 ± 0.39 | 50.94 ± 0.17 | 48.78 ± 0.45 |
| Palm 2 (Bard) | 81.74 ± 0.48 | 74.66 ± 0.96 | 61.17 ± 0.44 | 51.03 ± 0.11 | 49.00 ± 0.39 |
| Gemini | 80.86 ± 0.67 | 72.76 ± 0.37 | 61.02 ± 0.15 | 51.44 ± 0.49 | 48.82 ± 0.31 |
| Real Data | 77.79 ± 0.85 | 69.26 ± 1.07 | 63.35 ± 0.67 | 56.16 ± 0.38 | 50.69 ± 0.61 |

Overall, the downstream performance was best when GPT-3.5 was used to generate the textual descriptions. With the Random Forest classifier, the downstream performance of GPT-3.5 showed an overall improvement of 1.0% over GPT-4, 0.9% over LLaMa 2, 0.6% over Palm 2, and 0.8% over Gemini across all the datasets. Therefore, the study used GPT-3.5 for generating textual descriptions in subsequent experiments unless otherwise specified. Gemini and Palm 2 achieved competitive downstream performance (less than 1% difference compared to the other LLMs), despite producing worse textual descriptions with less context information.

When using the Random Forest classifier, the generated virtual IMU data led to better downstream performance for all datasets but one, HAD-AW. For Deep ConvLSTM, the results were mixed. The virtual IMU data did not improve HAR model performance for USC-HAD, HAD-AW, and the MyoGym datasets.

### Impact of Motion Synthesis Models on HAR

In addition to using various LLMs for generating textual descriptions of activities, the study also used various motion synthesis models to convert the textual descriptions into human motion sequences to determine how different generated motion sequences affect the downstream performance (e.g., downstream HAR).

The study converted 1,000 textual descriptions, generated by GPT-3.5, to motion sequences by using the four above-discussed motion synthesis models. The HAR models were trained on either real IMU data alone or on both the real IMU data and the virtual IMU data generated by the first experimental system using the four motion synthesis models.

Table 6 shows the downstream performance results (e.g., macro F1 scores) when different motion synthesis models were used in the first experimental system for virtual IMU data generation. “Real Data” denotes baseline experiments not including any generated, virtual IMU data.

TABLE 6

| | RealWorld | PAMAP2 | USC-HAD | HAD-AW | MyoGym |
|---|---|---|---|---|---|
| | Random Forest classifier | | | | |
| T2M-GPT | 79.70 ± 0.38 | 69.20 ± 0.29 | 49.72 ± 0.67 | 48.98 ± 0.11 | 47.93 ± 0.58 |
| MotionGPT | 79.19 ± 0.71 | 68.00 ± 0.28 | 49.72 ± 0.37 | 48.74 ± 0.03 | 47.73 ± 0.62 |
| MotionDiffuse | 79.23 ± 0.40 | 68.15 ± 0.43 | 48.91 ± 0.49 | 49.19 ± 0.09 | 46.77 ± 0.21 |
| ReMoDiffuse | 74.32 ± 0.87 | 67.81 ± 0.11 | 46.72 ± 0.30 | 50.05 ± 0.06 | 49.31 ± 0.27 |
| Real Data | 71.53 ± 1.07 | 67.08 ± 0.53 | 47.23 ± 0.08 | 52.77 ± 0.07 | 46.61 ± 0.09 |
| | Deep ConvLSTM | | | | |
| T2M-GPT | 82.25 ± 0.32 | 75.16 ± 0.82 | 61.44 ± 0.49 | 51.98 ± 0.28 | 49.46 ± 0.88 |
| MotionGPT | 81.45 ± 0.75 | 73.39 ± 0.53 | 60.72 ± 0.73 | 50.49 ± 0.15 | 46.35 ± 0.48 |
| MotionDiffuse | 82.03 ± 0.68 | 74.44 ± 0.75 | 61.07 ± 0.30 | 53.00 ± 0.30 | 46.78 ± 0.23 |
| ReMoDiffuse | 78.61 ± 0.45 | 73.80 ± 0.58 | 61.11 ± 0.86 | 53.49 ± 0.36 | 51.93 ± 0.57 |
| Real Data | 77.79 ± 0.85 | 69.26 ± 1.07 | 63.35 ± 0.67 | 56.16 ± 0.38 | 50.69 ± 0.61 |

T2M-GPT performed better for most of the datasets and across different HAR models. With the Random Forest classifier, the downstream performance of T2M-GPT showed an improvement of 0.7% over MotionGPT, 1.2% over MotionDiffuse, and 2.2% over ReMoDiffuse across all the datasets. However, for MyoGym, ReMoDiffuse appeared to be the better motion synthesis model. Due to the complex activities in HAD-AW, its results were worse than for real data.

### Diversity as a Predictor for HAR Model Performance

The study made two hypotheses that formed the basis for drawing a connection between the diversity of text and the downstream HAR model performance. The first hypothesis was that diversity in textual descriptions was correlated with diversity of the motion sequences generated by the descriptions. The second hypothesis was that diversity in motion sequences was correlated with performance for HAR models trained on the virtual data obtained from the sequences. The study validated the hypotheses by computing the correlation between the diversity of the textual descriptions and the motion sequences, and subsequently between motion sequences and the HAR model performance. The study also evaluated whether there was a correlation between the textual descriptions and the downstream performance.

Correlations. Using comparative diversity, the study computed the Pearson correlation coefficient between text diversity, motion diversity, and the change in the F1 score downstream. This process was similar to the saturation point identification algorithm (see FIG. 3C). For each activity, the study started with a set of 50 text descriptions, added 5% more textual descriptions at each step, and calculated the MMD between the two sets. Corresponding motion sequences and virtual IMU data were generated at each step. For the motion sequences, the study calculated the MMD in a similar manner. The study then used the virtual IMU data to train the HAR models, as in previous experiments, and compared the performance to the HAR models trained on only real IMU data to obtain the per-class change in F1 score. This process was repeated until reaching the saturation point (see FIG. 3C). Subsequently, the study had a list of values for text diversity, motion diversity, and changes in F1 scores, and the study computed the correlation between these three factors.

Table 7 shows the average correlations between comparative diversity of textual prompts, motion sequences, and the downstream performance result (e.g., macro F1 scores).

TABLE 7

| Dataset | RealWorld | PAMAP2 | USC-HAD | HAD-AW | MyoGym |
|---|---|---|---|---|---|
| Text vs. | r = 0.92, | r = 0.87, | r = 0.91, | r = 0.88, | r = 0.91, |
| Motion | p ≤ 0.001 | p ≤ 0.001 | p ≤ 0.001 | p ≤ 0.001 | p ≤ 0.001 |
| Text vs. F1 | r = −0.77, | r = −0.31, | r = −0.45, | r = 0.22, | r = −0.24, |
| | p ≤ 0.001 | p = 0.0052 | p = 0.004 | p = 0.173 | p = 0.136 |
| Motion vs. F1 | r = −0.76, | r = −0.32, | r = −0.46, | r = 0.21, | r = −0.24, |
| | p ≤ 0.001 | p = 0.044 | p = 0.003 | p = 0.193 | p = 0.136 |

In Table 7, text and motion diversity were correlated. For all but one dataset, HAD-AW, there was a negative moderate to strong correlation between the diversities and the downstream change in F1 score. The correlation was negative because a lower MMD indicated higher diversity. This suggested that the diversity metric could serve as a downstream performance predictor, where higher diversity indicated better performance. Specifically, the RealWorld dataset showed the strongest correlation, as the virtual IMU data contributed to improvements in the per-class F1 score across all activities. In contrast, for the USC-HAD, PAMAP2, and MyoGym datasets, the virtual IMU data led to a decline in the per-class F1 score for some activities, resulting in a more moderate correlation. For the HAD-AW dataset, the correlation was positive, indicating that the virtual IMU data led to a drop in the per-class F1 score for more activities than it helped.

Evaluation of the Saturation Point Identification Algorithm. To evaluate the saturation point identification algorithm (see FIG. 3C), the study used the algorithm to generate text descriptions for each activity across all the datasets. The study used the results in Table 5, where 1,000 textual descriptions were generated without a saturation point, as a baseline. Therefore, the study obtained two sets of text descriptions for each activity across all datasets: (i) a set having 1,000 descriptions without the saturation point, and (ii) a set generated using the saturation point identification algorithm (see FIG. 3C) that includes descriptions up to the saturation point.

Subsequently, the study generated virtual IMU data from the two sets of textual descriptions, combined the virtual IMU data with the corresponding real datasets, and used the combined data to train the HAR models. Table 8 shows the downstream HAR performance results (e.g., macro F1 scores) using real and virtual IMU data, with and without the saturation point identification algorithm.

TABLE 8

| | RealWorld | PAMAP2 | USC-HAD | HAD-AW | Myogym |
|---|---|---|---|---|---|
| | Random Forest classifier | | | | |
| Without saturation | 79.70 ± 0.38 | 69.20 ± 0.29 | 49.72 ± 0.67 | 48.98 ± 0.11 | 47.93 ± 0.58 |
| point | | | | | |
| With saturation | 80.39 ± 0.34 | 69.50 ± 0.54 | 50.07 ± 0.10 | 50.62 ± 0.05 | 48.73 ± 0.15 |
| point | | | | | |
| | Deep ConvLSTM | | | | |
| Without saturation | 82.25 ± 0.32 | 75.16 ± 0.82 | 61.44 ± 0.49 | 51.98 ± 0.28 | 49.46 ± 0.88 |
| point | | | | | |
| With saturation | 82.70 ± 0.49 | 75.47 ± 1.15 | 61.36 ± 0.38 | 52.37 ± 0.27 | 48.74 ± 0.36 |
| point | | | | | |

In Table 8, across all activities, datasets, and HAR models, the performance in the saturation point case was similar to, if not better than, without using the saturation point. The saturation points were computed for each activity individually. Most of the saturation points across all activities and datasets fell within the range of 400 to 600 textual descriptions, indicating that the algorithm stopped generation after that point. This suggested that the study could achieve equivalent performance while utilizing around 50% less data than directly generating 1,000 descriptions. Therefore, the study could save at least 50% of the time and compute the resources needed for data generation. The saturation point identification algorithm also provided a formal structure to guide the process of data generation in a manner that made it consistent and repeatable. In the absence of an algorithm, determining how many textual descriptions to generate and at what point to halt the generation can be challenging.

### Evaluation of the Motion Filtering Operation

The study also evaluated the effectiveness of the motion filtering operation in eliminating irrelevant motion sequences and its impact on the downstream performance.

Experimental Setting. The study used the RealWorld dataset for the evaluation. For each of the eight activities within the dataset, the study first generated 50 textual descriptions of the activity using GPT-3.5 [2], and then used T2MGPT to convert these descriptions into human motion sequences. FIG. 4 shows the resulting human motion sequences as 3D-animated visualizations. Using the visualizations, the study manually annotated whether the sequences portrayed the activity of interest. The manual annotations served as the ground truths for evaluating motion filtering performance.

The generated motion sequences were then processed using the motion filtering operation to distinguish the relevance of the motion sequence. Specifically, the study used GPT-3.5 and GPT-4 for the motion filtering operation to further explore the impact of LLMs on filtering performance. Besides using LLMs for labeling motion captions, the study manually annotated the captions generated by the motion caption model [26] to compare human and LLM performance. The performance of the motion filtering operation was evaluated with precision, recall, accuracy, F1 score, and percentage of incorrectly generated motion sequences before and after filtering. For each LLM, the study repeated the experiment five times on the same set of motion captions and reported averages and standard deviations for each performance metric.

Results. Table 9 shows the results (e.g., macro F1 scores) of the motion filtering operation using GPT-3.5, GPT-4, and human annotators to filter out incorrectly generated motion sequences based on motion captions. The motion filtering operation was configured to maximize true negatives (e.g., correctly identified inaccurate motion sequences) and minimize false positives (e.g., inaccurate sequences that the motion filtering operation missed). Therefore, an effective motion filtering operation should have high precision. In Table 9, the percentages of incorrectly generated motion sequences before and after the motion filtering operation are indicated as “% before filter” and “% after filter”, respectively.

TABLE 9

| | | | | | % | |
|---|---|---|---|---|---|---|
| | | | | | before | |
| Annotator | Precision | Recall | Accuracy | F1 | filter | % after filter |
| GPT-3.5 | 70.56 ± 0.84 | 71.49 ± 2.01 | 59.95 ± 1.01 | 67.93 ± 1.34 | 35.50% | 29.44% ± 0.84% |
| GPT-4 | 90.08 ± 0.63 | 60.55 ± 2.08 | 70.40 ± 0.88 | 71.12 ± 1.46 | 35.50% | 9.92% ± 0.63% |
| Human | 91.63 | 72.28 | 77.00 | 79.47 | 35.50% | 8.37% |

The choice of LLM impacted the performance of the motion filtering operation. In Table 9, GPT-4, with a precision of 0.901, outperformed GPT-3.5, with a precision of 0.706, and was comparable to the performance of the human annotators. When GPT-4 was used for motion filtering, the percentage of incorrectly generated motion sequences in the remaining dataset decreased from 35.5% before filtering to 9.9% after filtering.

Activity Recognition Performance. The study also examined the impact of the motion filtering operation on the downstream HAR performance. The study began with motion sequences generated by T2M-GPT from text descriptions produced by GPT-3.5. The captions of the motion sequences were input into GPT-4, which filtered out incorrectly generated motion sequences. The HAR models were then trained on the filtered datasets. Table 10 shows the downstream performance results (e.g., macro F1 scores) using real and virtual IMU data, with and without the motion filtering operation.

TABLE 10

| | RealWorld | PAMAP2 | USC-HAD | HAD-AW | Myogym |
|---|---|---|---|---|---|
| | Random Forest classifier | | | | |
| Without motion | 79.70 ± 0.38 | 69.20 ± 0.29 | 49.72 ± 0.67 | 48.98 ± 0.11 | 47.93 ± 0.58 |
| filtering | | | | | |
| operation | | | | | |
| With motion | 79.61 ± 0.44 | 70.22 ± 0.18 | 49.73 ± 0.14 | 51.09 ± 0.17 | 48.24 ± 0.19 |
| filtering | | | | | |
| operation | | | | | |
| | Deep ConvLSTM | | | | |
| Without motion | 82.25 ± 0.32 | 75.16 ± 0.82 | 61.44 ± 0.49 | 51.98 ± 0.28 | 49.46 ± 0.88 |
| filtering | | | | | |
| operation | | | | | |
| With motion | 81.45 ± 0.83 | 74.89 ± 1.14 | 61.75 ± 0.37 | 52.36 ± 0.20 | 51.94 ± 0.65 |
| filtering | | | | | |
| operation | | | | | |

In Table 10, the downstream performance results indicate that the motion filtering operation improved the downstream performance on the HAD-AW and MyoGym datasets, with relative improvements of 4.3% and 4.1%, respectively, compared to without the motion filtering operation.

However, for the other three datasets, the motion filtering operation did not affect downstream performance, contradicting the hypothesis in the study and the motion filtering validation results. The study found that motion filtering could reduce the diversity of generated motion sequences, favoring similar motion sequences, due to LLM biases, which could contribute to the decrease in the downstream performance.

### CONCLUSION

The construction and arrangement of the systems and methods, as shown in the various implementations, are illustrative only. Although only a few implementations have been described in detail in this disclosure, many modifications are possible (e.g., variations in sizes, dimensions, structures, shapes, proportions of the various elements, values of parameters, mounting arrangements, use of materials, colors, orientations, etc.). For example, the position of elements may be reversed or otherwise varied, and the nature or number of discrete elements or positions may be altered or varied. Accordingly, all such modifications are intended to be included within the scope of the present disclosure. The order or sequence of any process or method steps may be varied or re-sequenced according to alternative implementations. Other substitutions, modifications, changes, and omissions may be made in the design, operating conditions, and arrangement of the implementations without departing from the scope of the present disclosure.

The present disclosure contemplates methods, systems, and program products on any machine-readable media for accomplishing various operations. The implementations of the present disclosure may be implemented using existing computer processors, or by a special-purpose computer processor for an appropriate system, incorporated for this or another purpose, or by a hardwired system. Implementations within the scope of the present disclosure include program products, including machine-readable media for carrying or having machine-executable instructions or data structures stored thereon. Such machine-readable media can be any available media that can be accessed by a general-purpose or special-purpose computer or other machine with a processor. By way of example, such machine-readable media can comprise RAM, ROM, EPROM, EEPROM, CD-ROM or other optical disk storage, magnetic disk storage or other magnetic storage devices, or any other medium which can be used to carry or store desired program code in the form of machine-executable instructions or data structures, and which can be accessed by a general purpose or special purpose computer or other machine with a processor.

When information is transferred or provided over a network or another communications connection (either hardwired, wireless, or a combination of hardwired or wireless) to a machine, the machine properly views the connection as a machine-readable medium; thus, any such connection is properly termed a machine-readable medium. Combinations of the above are also included within the scope of machine-readable media. Machine-executable instructions include, for example, instructions and data that cause a general-purpose computer, special-purpose computer, or special-purpose processing machine to perform a certain function or group of functions.

Although the figures show a specific order of method steps, the order of the steps may differ from what is depicted. Also, two or more steps may be performed concurrently or with partial concurrence. Such variation will depend on the software and hardware systems chosen and on the designer's choice. All such variations are within the scope of the disclosure. Likewise, software implementations could be accomplished with programming techniques with rule-based logic and other logic to accomplish the various connection steps, processing steps, comparison steps, and decision steps.

It is to be understood that the methods and systems are not limited to specific synthetic methods, specific components, or particular compositions. It is also to be understood that the terminology used herein is for the purpose of describing particular implementations only and is not intended to be limiting.

As used in the specification and the appended claims, the singular forms “a,” “an” and “the” include plural referents unless the context clearly dictates otherwise. Ranges may be expressed herein as from “about” one particular value, and/or to “about” another particular value. When such a range is expressed, another implementation includes from the one particular value and/or to the other particular value. Similarly, when values are expressed as approximations, by use of the antecedent “about,” it will be understood that the particular value forms another implementation. It will be further understood that the endpoints of each of the ranges are significant both in relation to the other endpoint and independently of the other endpoint.

“Optional” or “optionally” means that the subsequently described event or circumstance may or may not occur and that the description includes instances where said event or circumstance occurs and instances where it does not.

Throughout the description and claims of this specification, the word “comprise” and variations of the word, such as “comprising” and “comprises,” mean “including but not limited to,” and are not intended to exclude, for example, other additives, components, integers, or steps. “Exemplary” means “an example of” and is not intended to convey an indication of a preferred or ideal implementation. “Such as” is not used in a restrictive sense but for explanatory purposes.

Disclosed are components that can be used to perform the disclosed methods and systems. These and other components are disclosed herein, and it is understood that when combinations, subsets, interactions, groups, etc. of these components are disclosed while specific reference to each various individual and collective combinations and permutations of these may not be explicitly disclosed, each is specifically contemplated and described herein, for all methods and systems. This applies to all aspects of this application, including, but not limited to, steps in disclosed methods. Thus, if there are a variety of additional steps that can be performed, it is understood that each of these additional steps can be performed with any specific implementation or combination of implementations of the disclosed methods.

The following patents, applications, and publications, as listed below and throughout this document, are hereby incorporated by reference in their entirety herein.

### REFERENCE LIST

[1] 2021. sentence-transformers/all-mpnet-base-v2. https://huggingface.co/sentence-transformers/all-mpnet-base-v2 (2024 Feb. 1).
[2] 2022. GPT-3.5. https://platform.openai.com/docs/models/gpt-3-5 (2024 Feb. 1).
[3] 2023. REDUCELRONPLATEAU. https://pytorch.org/docs/stable/generated/torch.optim.lr_scheduler.ReduceLROnPlateau.html (2024 Feb. 1).
[4] Karan Ahuja, Yue Jiang, Mayank Goel, and Chris Harrison. 2021. Vid2Doppler: Synthesizing Doppler radar data from videos for training privacy-preserving activity recognition. In Proceedings of the 2021 CHI Conference on Human Factors in Computing Systems. 1-10.
[5] Rohan Anil, Andrew M. Dai, Orhan Firat, Melvin Johnson, Dmitry Lepikhin, Alexandre Passos, Siamak Shakeri, Emanuel Taropa, Paige Bailey, Zhifeng Chen, Eric Chu, Jonathan H. Clark, Laurent El Shafey, Yanping Huang, Kathy Meier-Hellstern, et al. 2023. PaLM 2 Technical Report. arXiv: 2305.10403 [cs.CL]
[6] Matthias Bächlin, Meir Plotnik, Daniel Roggen, Nir Giladi, Jeffrey M Hausdorff, and Gerhard Tröster. 2010. Wearable assistant for Parkinson's disease patients with the freezing of gait symptom. IEEE Transactions on Information Technology in Biomedicine 14, 2 (2010), 436-446. https://doi.org/10.1109/TITB.2009.2036165
[7] Lei Bai, Lina Yao, Xianzhi Wang, Salil S. Kanhere, Bin Guo, and Zhiwen Yu. 2020. Adversarial Multi-view Networks for Activity Recognition. Proc. ACM Interact. Mob. Wearable Ubiquitous Technol. 4, 2, Article 42 (June 2020), 22 pages. https://doi.org/10.1145/3397323
[8] Lei Bai, Lina Yao, Xianzhi Wang, Salil S. Kanhere, and Yang Xiao. 2020. Prototype Similarity Learning for Activity Recognition. In Advances in Knowledge Discovery and Data Mining, Hady W. Lauw, Raymond Chi-Wing Wong, Alexandros Ntoulas, Ee-Peng Lim, See-Kiong Ng, and Sinno Jialin Pan (Eds.). Springer International Publishing, Cham, 649-661.
[9] Dmitrijs Balabka. 2019. Semi-supervised learning for human activity recognition using adversarial autoencoders. In Adjunct Proceedings of the 2019 ACM International Joint Conference on Pervasive and Ubiquitous Computing and Proceedings of the 2019 ACM International Symposium on Wearable Computers (London, United Kingdom) (UbiComp/ISWC'19 Adjunct). Association for Computing Machinery, New York, NY, USA, 685-688. https://doi.org/10.1145/3341162.3344854
[10] Sejal Bhalla, Mayank Goel, and Rushil Khurana. 2021. IMU2Doppler: Cross-Modal Domain Adaptation for Doppler-based Activity Recognition Using IMU Data. Proceedings of the ACM on Interactive, Mobile, Wearable and Ubiquitous Technologies 5, 4 (2021), 1-20.
[11] Tom Brown, Benjamin Mann, Nick Ryder, Melanie Subbiah, Jared D Kaplan, Prafulla Dhariwal, Arvind Neelakantan, Pranav Shyam, Girish Sastry, Amanda Askell, Sandhini Agarwal, Ariel Herbert-Voss, Gretchen Krueger, Tom Henighan, Rewon Child, et al. 2020. Language Models are Few-Shot Learners. In Advances in Neural Information Processing Systems, Vol. 33. Curran Associates, Inc., 1877-1901.
[12] Ricardo Chavarriaga, Hesam Sagha, Alberto Calatroni, Sundara Tejaswi Digumarti, Gerhard Tröster, José del R Millán, and Daniel Roggen. 2013. The opportunity challenge: a benchmark database for on-body sensor-based activity recognition. Pattern Recognition Letters 34, 15 (2013), 2033-2042. https://doi.org/10.1016/j.patrec.2012.12.014
[13] Wenqiang Chen, Shupei Lin, Elizabeth Thompson, and John Stankovic. 2021. SenseCollect: We Need Efficient Ways to Collect On-body Sensor-based Human Activity Data! Proceedings of the ACM on Interactive, Mobile, Wearable and Ubiquitous Technologies 5, 3 (2021), 1-27.
[14] Dongzhou Cheng, Lei Zhang, Can Bu, Xing Wang, Hao Wu, and Aiguo Song. 2023. ProtoHAR: Prototype Guided Personalized Federated Learning for Human Activity Recognition. IEEE Journal of Biomedical and Health Informatics 27, 8 (2023), 3900-3911. https://doi.org/10.1109/JBHI.2023.3275438
[15] L. Cilliers. 2020. Wearable devices in healthcare: Privacy and information security issues. Health Information Management Journal 49, 2-3 (2020), 150-156.
[16] Richard O. Duda, Peter E. Hart, and David G. Stork. 2000. Pattern Classification (2nd Edition) (2 ed.). Wiley-Interscience.
[17] Floyd Els and Liezel Cilliers. 2017. Improving the information security of personal electronic health records to protect a patient's health information. In 2017 Conference on Information Communication Technology and Society (ICTAS). 1-6. https://doi.org/10.1109/ICTAS.2017. 7920658
[18] Siwei Feng and Marco F. Duarte. 2019. Few-shot learning-based human activity recognition. Expert Systems with Applications 138 (2019), 112782. https://doi.org/10.1016/j.eswa.2019.06.070
[19] Arthur Gretton, Karsten M. Borgwardt, Malte J. Rasch, Bernhard Schölkopf, and Alexander Smola. 2012. A Kernel Two-Sample Test. Journal of Machine Learning Research 13, 25 (2012), 723-773. http://jmlr.org/papers/v13/gretton12a.html
[20] Chuan Guo, Shihao Zou, Xinxin Zuo, Sen Wang, Wei Ji, Xingyu Li, and Li Cheng. 2022. Generating Diverse and Natural 3D Human Motions From Text. In Proceedings of the IEEE/CVF Conference on Computer Vision and Pattern Recognition (CVPR). 5152-5161.
[21] Chuan Guo, Xinxin Zuo, Sen Wang, and Li Cheng. 2022. TM2T: Stochastic and Tokenized Modeling for the Reciprocal Generation of 3D Human Motions and Texts. In ECCV.
[22] N. Y. Hammerla, R. Kirkham, P. Andras, and T. Ploetz. 2013. On preserving statistical characteristics of accelerometry data using their empirical cumulative distribution. In Proceedings of the 2013 international symposium on wearable computers. 65-68.
[23] Harish Haresamudram, Apoorva Beedu, Varun Agrawal, Patrick L. Grady, Irfan Essa, Judy Hoffman, and Thomas Plötz. 2020. Masked reconstruction based self-supervision for human activity recognition. In Proceedings of the 2020 ACM International Symposium on Wearable Computers (Virtual Event, Mexico) (ISWC '20). Association for Computing Machinery, New York, NY, USA, 45-49. https://doi.org/10.1145/3410531.3414306
[24] Harish Haresamudram, Irfan Essa, and Thomas Plötz. 2021. Contrastive Predictive Coding for Human Activity Recognition. 5, 2, Article 65 (June 2021), 26 pages. https://doi.org/10.1145/3463506
[25] Harish Haresamudram, Irfan Essa, and Thomas Plötz. 2022. Assessing the state of self-supervised human activity recognition using wearables. Proceedings of the ACM on Interactive, Mobile, Wearable and Ubiquitous Technologies 6, 3 (2022), 1-47.
[26] Biao Jiang, Xin Chen, Wen Liu, Jingyi Yu, Gang Yu, and Tao Chen. 2023. MotionGPT: Human Motion as a Foreign Language. arXiv preprint arXiv: 2306.14795 (2023).
[27] D. Jiang and G. Shi. 2021. Research on data security and privacy protection of wearable equipment in healthcare. Journal of Healthcare Engineering 2021 (2021).
[28] Takeshi Kojima, Shixiang (Shane) Gu, Machel Reid, Yutaka Matsuo, and Yusuke Iwasawa. 2022. Large Language Models are Zero-Shot Reasoners. In Advances in Neural Information Processing Systems, S. Koyejo, S. Mohamed, A. Agarwal, D. Belgrave, K. Cho, and A. Oh (Eds.), Vol. 35. Curran Associates, Inc., 22199-22213. https://proceedings.neurips.cc/paper_files/paper/2022/file/8bb0d291acd4acf06ef112099c16f3 26-Paper-Conference.pdf
[29] Heli Koskimäki, Pekka Siirtola, and Juha Röning. 2017. MyoGym: Introducing an Open Gym Data Set for Activity Recognition Collected Using Myo Armband. In Proceedings of the 2017 ACM International Joint Conference on Pervasive and Ubiquitous Computing and Proceedings of the 2017 ACM International Symposium on Wearable Computers. Association for Computing Machinery, New York, NY, USA. https://doi.org/10.1145/3123024.3124400
[30] Taku Kudo and John Richardson. 2018. SentencePiece: A simple and language independent subword tokenizer and detokenizer for Neural Text Processing. arXiv: 1808.06226 [cs. CL]
[31] Hyeokhyen Kwon, Gregory D Abowd, and Thomas Plötz. 2019. Handling annotation uncertainty in human activity recognition. In Proceedings of the 23rd International Symposium on Wearable Computers. 109-117.
[32] Hyeokhyen Kwon, Gregory D Abowd, and Thomas Plötz. 2021. Complex Deep Neural Networks from Large Scale Virtual IMU Data for Effective Human Activity Recognition Using Wearables. Sensors 21, 24 (2021), 8337.
[33] Hyeokhyen Kwon, Catherine Tong, Harish Haresamudram, Yan Gao, Gregory D Abowd, Nicholas D Lane, and Thomas Ploetz. 2020. IMUTube: Automatic extraction of virtual on-body accelerometry from video for human activity recognition. Proceedings of the ACM on Interactive, Mobile, Wearable and Ubiquitous Technologies 4, 3 (2020), 1-29.
[34] Hyeokhyen Kwon, Bingyao Wang, Gregory D Abowd, and Thomas Plötz. 2021. Approaching the Real-World: Supporting Activity Recognition Training with Virtual IMU Data. Proceedings of the ACM on Interactive, Mobile, Wearable and Ubiquitous Technologies 5, 3 (2021), 1-32.
[35] Julia Lahn, Heiko Peter, and Peter Braun. 2015. Car Crash Detection on Smartphones (iWOAR '15). Association for Computing Machinery, New York, NY, USA. https://doi.org/10.1145/2790044.2790049
[36] Yi-An Lai, Xuan Zhu, Yi Zhang, and Mona Diab. [n. d.]. Diversity, Density, and Homogeneity: Quantitative Characteristic Metrics for Text Collections. ([n. d.]).
[37] Clayton Frederick Souza Leite and Yu Xiao. 2020. Improving Cross-Subject Activity Recognition via Adversarial Learning. IEEE Access 8 (2020), 90542-90554. https://doi.org/10.1109/ACCESS.2020.2993818
[39] Zikang Leng, Yash Jain, Hyeokhyen Kwon, and Thomas Ploetz. 2023. On the Utility of Virtual On-body Acceleration Data for Fine-grained Human Activity Recognition. In Proceedings of the 2023 ACM International Symposium on Wearable Computers (ISWC '23). Association for Computing Machinery, New York, NY, USA. https://doi.org/10.1145/3594738.3611364
[39] Zikang Leng, Hyeokhyen Kwon, and Thomas Ploetz. 2023. Generating Virtual On-Body Accelerometer Data from Virtual Textual Descriptions for Human Activity Recognition. In Proceedings of the 2023 ACM International Symposium on Wearable Computers. Association for Computing Machinery, New York, NY, USA. https://doi.org/10.1145/3594738.3611361
[40] Jiyang Li, Lin Huang, Siddharth Shah, Sean J. Jones, Yincheng Jin, Dingran Wang, Adam Russell, Seokmin Choi, Yang Gao, Junsong Yuan, and Zhanpeng Jin. 2023. SignRing: Continuous American Sign Language Recognition Using IMU Rings and Virtual IMU Data. Proc. ACM Interact. Mob. Wearable Ubiquitous Technol. 7, 3, Article 107 (September 2023), 29 pages. https://doi.org/10.1145/3610881
[41] Dawei Liang, Guihong Li, Rebecca Adaimi, Radu Marculescu, and Edison Thomaz. 2022. AudioIMU: Enhancing Inertial Sensing-Based Activity Recognition with Acoustic Models. In Proceedings of the 2022 ACM International Symposium on Wearable Computers. 44-48.
[42] Daniyal Liaqat, Mohamed Abdalla, Pegah Abed-Esfahani, Moshe Gabel, Tatiana Son, Robert Wu, Andrea Gershon, Frank Rudzicz, and Eyal De Lara. 2019. WearBreathing: Real World Respiratory Rate Monitoring Using Smartwatches. Proc. ACM Interact. Mob. Wearable Ubiquitous Technol. 3, 2, Article 56 (June 2019), 22 pages. https://doi.org/10.1145/3328927
[43] Jing Lin, Ailing Zeng, Shunlin Lu, Yuanhao Cai, Ruimao Zhang, Haoqian Wang, and Lei Zhang. 2023. Motion-X: A Large-scale 3D Expressive Whole-body Human Motion Dataset. Advances in Neural Information Processing Systems (2023).
[44] Jiawei Liu, Xiaohu Li, Shanshan Huang, Rui Chao, Zhidong Cao, Shu Wang, Aiguo Wang, and Li Liu. 2023. A review of wearable sensors based fall-related recognition systems. Engineering Applications of Artificial Intelligence 121 (2023), 105993. https://doi.org/10.1016/j. engappai.2023.105993
[45] Yilin Liu, Fengyang Jiang, and Mahanth Gowda. 2020. Finger Gesture Tracking for Interactive Applications: A Pilot Study with Sign Languages. 4, 3 (2020). https://doi.org/10.1145/3414117
[46] Yilin Liu, Shijia Zhang, and Mahanth Gowda. 2021. When Video Meets Inertial Sensors: Zero-Shot Domain Adaptation for Finger Motion Analytics with Inertial Sensors. In Proceedings of the International Conference on Internet-of-Things Design and Implementation (Charlottesvle, VA, USA) (IoTDI '21). Association for Computing Machinery, New York, NY, USA, 182-194. https://doi.org/10.1145/3450268.3453537
[47] Matthew Loper, Naureen Mahmood, Javier Romero, Gerard Pons-Moll, and Michael J. Black. 2015. SMPL: A Skinned Multi-Person Linear Model. ACM Trans. Graph. 34, 6, Article 248 (November 2015), 16 pages. https://doi.org/10.1145/2816795.2818013
[48] Min Yen Lu, ChenHao Chen, Shigemi Ishida, Yugo Nakamura, and Yutaka Arakawa. 2022. A study on estimating the accurate head IMU motion from Video. Proceedings of the Symposium on Multimedia, Distributed, Cooperative, and Mobile (DICOMO) 2022 2022 (07 2022), 918-923. https://cir.nii.ac.jp/crid/1050011771467456512
[49] David Martin, Zikang Leng, Tan Gemicioglu, Jon Womack, Jocelyn Heath, William C Neubauer, Hyeokhyen Kwon, Thomas Ploetz, and Thad Starner. 2023. FingerSpeller: Camera-Free Text Entry Using Smart Rings for American Sign Language Fingerspelling Recognition. In Proceedings of the 25th International ACM SIGACCESS Conference on Computers and Accessibility. Association for Computing Machinery, New York, NY, USA. https://doi.org/10.1145/3597638.3614491
[50] Sara Mohammed, Reda Elbasiony, and Walid Gomaa. 2018. An LSTM-based Descriptor for Human Activities Recognition using IMU Sensors. 504-511. https://doi.org/10.5220/0006902405040511
[51] F. Mohd-Yasin, C. E. Korman, and D. J. Nagel. 2001. Measurement of noise characteristics of MEMS accelerometers. In 2001 International Semiconductor Device Research Symposium. Symposium Proceedings (Cat. No.01EX497). 190-193. https://doi.org/10.1109/ISDRS.2001.984472
[52] OpenAI: Josh Achiam, Steven Adler, Sandhini Agarwal, Lama Ahmad, Ilge Akkaya, Florencia Leoni Aleman, Diogo Almeida, Janko Altenschmidt, Sam Altman, Shyamal Anadkat, Red Avila, Igor Babuschkin, Suchir Balaji, Valerie Balcom, et al. 2023. GPT-4 Technical Report. arXiv: 2303.08774 [cs. CL]
[53] Francisco Javier Ordóñez and Daniel Roggen. 2016. Deep Convolutional and LSTM Recurrent Neural Networks for Multimodal Wearable Activity Recognition. Sensors (2016).
[54] Thomas Plötz. 2023. If only we had more data!: Sensor-Based Human Activity Recognition in Challenging Scenarios. In 2023 IEEE International Conference on Pervasive Computing and Communications Workshops and other Affiliated Events (PerCom Workshops). 565-570. https://doi.org/10.1109/PerComWorkshops56833.2023.10150267
[55] Colin Raffel, Noam Shazeer, Adam Roberts, Katherine Lee, Sharan Narang, Michael Matena, Yanqi Zhou, Wei Li, and Peter J. Liu. 2020. Exploring the Limits of Transfer Learning with a Unified Text-to-Text Transformer. Journal of Machine Learning Research 21, 140 (2020), 1-67. http://jmlr.org/papers/v21/20-074.html
[56] Daniele Ravi, Charence Wong, Benny Lo, and Guang-Zhong Yang. 2016. Deep learning for human activity recognition: A resource efficient implementation on low-power devices. In 2016 IEEE 13th International Conference on Wearable and Implantable Body Sensor Networks (BSN). 71-76. https://doi.org/10.1109/BSN.2016.7516235
[57] Nils Reimers and Iryna Gurevych. 2019. Sentence-BERT: Sentence Embeddings using Siamese BERT-Networks. In Proceedings of the 2019 Conference on Empirical Methods in Natural Language Processing. Association for Computational Linguistics. http://arxiv.org/abs/1908.10084
[58] Attila Reiss and Didier Stricker. 2012. Introducing a New Benchmarked Dataset for Activity Monitoring (ISWC′12). IEEE Computer Society. https://doi.org/10.1109/ISWC.2012.13
[59] Vitor Fortes Rey, Peter Hevesi, Onorina Kovalenko, and Paul Lukowicz. 2019. Let There Be IMU Data: Generating Training Data for Wearable, Motion Sensor Based Activity Recognition from Monocular RGB Videos. In Adjunct Proceedings of the 2019 ACM International Joint Conference on Pervasive and Ubiquitous Computing and Proceedings of the 2019 ACM International Symposium on Wearable Computers. Association for Computing Machinery, 699-708. https://doi.org/10.1145/3341162.3345590
[60] Aaqib Saeed, Tanir Ozcelebi, and Johan Lukkien. 2019. Multi-task Self-Supervised Learning for Human Activity Detection. Proc. ACM Interact. Mob. Wearable Ubiquitous Technol. 3, 2, Article 61 (June 2019), 30 pages. https://doi.org/10.1145/3328932
[61] Panneer Selvam Santhalingam, Parth Pathak, Huzefa Rangwala, and Jana Kosecka. 2023. Synthetic Smartwatch IMU Data Generation from In-the-Wild ASL Videos. Proc. ACM Interact. Mob. Wearable Ubiquitous Technol. (2023).
[62] Allah Bux Sargano, Xiaofeng Wang, Plamen Angelov, and Zulfiqar Habib. 2017. Human action recognition using transfer learning with deep representations. In 2017 International Joint Conference on Neural Networks (IJCNN). 463-469. https://doi.org/10.1109/IJCNN.2017. 7965890
[63] Yongliang Shen, Kaitao Song, Xu Tan, Dongsheng Li, Weiming Lu, and Yueting Zhuang. 2023. HuggingGPT: Solving AI Tasks with ChatGPT and its Friends in HuggingFace. arXiv: 2303.17580 [cs.CL]
[64] Satya P. Singh, Madan Kumar Sharma, Aimé Lay-Ekuakille, Deepak Gangwar, and Sukrit Gupta. 2021. Deep ConvLSTM With Self-Attention for Human Activity Decoding Using Wearable Sensors. IEEE Sensors Journal 21, 6 (2021), 8575-8582. https://doi.org/10.1109/JSEN.2020.3045135
[65] Timo Sztyler and Heiner Stuckenschmidt. 2016. On-body localization of wearable devices: An investigation of position-aware activity recognition. In 2016 IEEE International Conference on Pervasive Computing and Communications (PerCom). 1-9. https://doi.org/10.1109/PERCOM.2016.7456521
[66] Chi Ian Tang, Ignacio Perez-Pozuelo, Dimitris Spathis, Soren Brage, Nick Wareham, and Cecilia Mascolo. 2021. SelfHAR: Improving Human Activity Recognition through Self-training with Unlabeled Data. Proceedings of the ACM on Interactive, Mobile, Wearable and Ubiquitous Technologies 5, 1 (March 2021), 1-30. https://doi.org/10.1145/3448112
[67] Gemini Team, Rohan Anil, Sebastian Borgeaud, Yonghui Wu, Jean-Baptiste Alayrac, Jiahui Yu, Radu Soricut, Johan Schalkwyk, Andrew M. Dai, Anja Hauth, Katie Millican, David Silver, Slav Petrov, Melvin Johnson, and Ioannis Antonoglou others. 2023. Gemini: A Family of Highly Capable Multimodal Models. arXiv: 2307.09288 [cs.CL]
[68] Hugo Touvron, Thibaut Lavril, Gautier Izacard, Xavier Martinet, Marie-Anne Lachaux, Timothée Lacroix, Baptiste Rozière, Naman Goyal, Eric Hambro, Faisal Azhar, Aurelien Rodriguez, Armand Joulin, Edouard Grave, and Guillaume Lample. 2023. LLaMA: Open and Efficient Foundation Language Models. arXiv: 2302.13971 [cs.CL]
[69] Lena Uhlenberg and Oliver Amft. 2022. Comparison of Surface Models and Skeletal Models for Inertial Sensor Data Synthesis. In 2022 IEEE-EMBS International Conference on Wearable and Implantable Body Sensor Networks (BSN). 1-5. https://doi.org/10.1109/BSN56160. 2022.9928504
[70] Aaron van den Oord, Oriol Vinyals, and Koray Kavukcuoglu. 2017. Neural Discrete Representation Learning. In Proceedings of the 31st International Conference on Neural Information Processing Systems (NIPS′17). 6309-6318.
[71] Vincent T. van Hees, Zhou Fang, Joss Langford, Felix Assah, Anwar Mohammad, Inacio C. M. da Silva, Michael I. Trenell, Tom White, Nicholas J. Wareham, and Søren Brage. 2014. Autocalibration of accelerometer data for free-living physical activity assessment using local gravity and temperature: an evaluation on four continents. Journal of Applied Physiology 117, 7 (2014), 738-744. https://doi.org/10.1152/japplphysiol.00421.2014 arXiv: https://doi.org/10.1152/japplphysiol.00421.2014 PMID: 25103964.
[72] Chenfei Wu, Shengming Yin, Weizhen Qi, Xiaodong Wang, Zecheng Tang, and Nan Duan. 2023. Visual ChatGPT: Talking, Drawing and Editing with Visual Foundation Models. arXiv: 2303.04671 [cs.CV]
[73] Chengshuo Xia, Ayane Saito, and Yuta Sugiura. 2022. Using the virtual data-driven measurement to support the prototyping of hand gesture recognition interface with distance sensor. Sensors and Actuators A: Physical 338 (2022), 113463.
[74] Chengshuo Xia and Yuta Sugiura. 2022. Virtual IMU Data Augmentation by Spring-Joint Model for Motion Exercises Recognition without Using Real Data. In Proceedings of the 2022 ACM International Symposium on Wearable Computers (ISWC '22). Association for Computing Machinery, 79-83. https://doi.org/10.1145/3544794.3558460
[75] Fanyi Xiao, Ling Pei, Lei Chu, Danping Zou, Wenxian Yu, Yifan Zhu, and Tao Li. 2021. A Deep Learning Method for Complex Human Activity Recognition Using Virtual Wearable Sensors. In Spatial Data and Intelligence. Springer International Publishing. https://doi.org/10.1007/978-3-030-69873-7_19
[76] Chenhan Xu, Huining Li, Zhengxiong Li, Xingyu Chen, Aditya Singh Rathore, Hanbin Zhang, Kun Wang, and Wenyao Xu. 2022. The Visual Accelerometer: A High-fidelity Optic-to-Inertial Transformation Framework for Wearable Health Computing. In 2022 IEEE 10th International Conference on Healthcare Informatics (ICHI). IEEE, 319-329.
[77] Hyungjun Yoon, Hyeongheon Cha, Canh Hoang Nguyen, Taesik Gong, and Sung-Ju Lee. 2022. IMG2IMU: Applying Knowledge from Large-Scale Images to IMU Applications via Contrastive Learning. arXiv preprint arXiv: 2209.00945 (2022).
[78] A. D. Young, M. J. Ling, and D. K. Arvind. 2011. IMUSim: A simulation environment for inertial sensing algorithm design and evaluation. In Proceedings of the 10th ACM/IEEE International Conference on Information Processing in Sensor Networks. 199-210.
[79] Jianrong Zhang, Yangsong Zhang, Xiaodong Cun, Shaoli Huang, Yong Zhang, Hongwei Zhao, Hongtao Lu, and Xi Shen. 2023. T2M-GPT: Generating Human Motion from Textual Descriptions with Discrete Representations. In Proceedings of the IEEE/CVF Conference on Computer Vision and Pattern Recognition (CVPR).
[80] Mingyuan Zhang, Zhongang Cai, Liang Pan, Fangzhou Hong, Xinying Guo, Lei Yang, and Ziwei Liu. 2022. MotionDiffuse: Text-Driven Human Motion Generation with Diffusion Model. arXiv preprint arXiv: 2208.15001 (2022).
[81] Mingyuan Zhang, Xinying Guo, Liang Pan, Zhongang Cai, Fangzhou Hong, Huirong Li, Lei Yang, and Ziwei Liu. 2023. ReMoDiffuse: Retrieval-Augmented Motion Diffusion Model. arXiv preprint arXiv: 2304.01116 (2023).
[82] Mi Zhang and Alexander A. Sawchuk. 2012. USC-HAD: A Daily Activity Dataset for Ubiquitous Activity Recognition Using Wearable Sensors. Association for Computing Machinery.
[83] Shibo Zhang and Nabil Alshurafa. 2020. Deep Generative Cross-Modal on-Body Accelerometer Data Synthesis from Videos. In Adjunct Proceedings of the 2020 ACM International Joint Conference on Pervasive and Ubiquitous Computing and Proceedings of the 2020 ACM International Symposium on Wearable Computers (UbiComp/ISWC'20 Adjunct). Association for Computing Machinery, 223-227.

What is claimed:

1. A system for generating training data for artificial intelligence (AI) or machine learning (ML) models to detect or recognize an activity of a subject, the system comprising:
a controller comprising:
a processor; and
a memory having instructions stored thereon, wherein execution of the instructions causes the processor to:
receive a first dataset comprising a plurality of activity descriptions for the subject;
generate, via a motion synthesis model, as a first trained AI model, a set of motion sequence data objects representing motion sequences corresponding with the plurality of activity descriptions, wherein each motion sequence data object represents a motion within the motion sequences, and wherein the generation of the set of motion sequence data objects includes an iterative data-variability evaluation operation;
generate, using the generated set of motion sequence data objects, a second dataset comprising a set of properties of each motion sequence; and
output the generated second dataset, wherein the output generated second data is subsequently used for training the AI or ML models to detect or recognize the activity of the subject.

2. The system of claim 1, wherein the motion synthesis model is a neural network trained using a dataset comprising motion sequence data objects acquired from a set of subjects and coupled with corresponding descriptions of activities performed by the set of subjects.

3. The system of claim 1, wherein the received first dataset is generated, via a second trained AI model, using data representing name or type of the activity of the subject as an input, wherein the second trained AI model is a large language model (LLM) trained using a dataset comprising descriptions of activities performed by a set of subjects.

4. The system of claim 3, wherein the iterative data-variability evaluation operation comprises:
generating, in a given iteration, vectorial representations for the plurality of activity descriptions, wherein each vectorial representation includes semantic and syntactic data of a respective description within the first dataset, and wherein the vectorial representations form one or more vectorial clusters;
determining, in the given iteration, a diversity score value representing variability among the generated vectorial representations in the given iteration, including (i) distributions of the one or more vectorial clusters and (ii) spatial distances between centers of vectorial clusters and respective vectorial representations therein;
determining a difference between the determined diversity score value in the given iteration and a diversity score value in a previous iteration; and
in response to the determined difference exceeding a variability threshold among the generated vectorial representations, generating, in subsequent iterations, additional activity descriptions until a difference in diversity score values of two consecutive subsequent iterations fails to exceed the variability threshold, wherein the variability threshold in a predefined value or a value determined based on convergence of diversity score values across previous iterations.

5. The system of claim 1, wherein the generation of the set of motion sequence data objects includes a second iterative operation comprising:
generating, in a given iteration, vectorial representations for the set of motion sequence data objects, wherein each vectorial representation corresponds to a respective motion sequence data object, and wherein the vectorial representations form one or more vectorial clusters;
determining, in the given iteration, a diversity score value representing variability among the generated vectorial representations in the given iteration, including (i) distributions of the one or more vectorial clusters and (ii) spatial distances between centers of vectorial clusters and respective vectorial representations therein;
determining a difference between the determined diversity score value in the given iteration and a diversity score value in a previous iteration; and
in response to the determined difference exceeding a variability threshold among the generated vectorial representations, generating, in subsequent iterations, additional motion sequence data objects until a difference in diversity score values in two consecutive subsequent iterations fails to exceed the variability threshold.

6. The system of claim 4, wherein the execution of the instructions further causes the processor to remove, via a motion filtering operation, motion sequence data objects inconsistent with the plurality of activity descriptions, wherein the motion filtering operation comprises:
receiving the generated set of motion sequence data objects;
encoding, via a third trained AI model, the generated set of motion sequence data objects into a set of tokens, each token representing a respective motion sequence data object, wherein the third trained AI model was trained using a language dataset coupled with motion sequence data acquired from a set of people;
generating, via the third trained AI model, a set of motion descriptions, as input to the second trained AI model, for the generated set of motion sequence data objects encoded in the generated set of tokens;
determining, via the second trained AI model, one or more motion descriptions within the generated set of motion descriptions as being inconsistent with the plurality of activity descriptions; and
removing motion sequence data objects associated with the one or more motion descriptions determined as being inconsistent with the plurality of activity descriptions.

7. The system of claim 6, wherein the determining of the one or more motion descriptions as being inconsistent with the plurality of activity descriptions comprises:
labeling motion descriptions within the generated set of motion descriptions with binary classification values, including a first binary classification value, and wherein the one or more motion descriptions determined as being inconsistent with the plurality of activity descriptions are labeled with the first binary classification value.

8. The system of claim 6, wherein the determining of the one or more motion descriptions as being consistent with the plurality of activity descriptions is based on one or more evaluation metrics, including similarity score values between the one or more motion descriptions and the plurality of activity descriptions.

9. The system of claim 1, wherein the set of properties of each motion sequence comprises acceleration property values, angular velocity property values, orientation property values, magnetometry property values, or a combination thereof.

10. The system of claim 1, wherein the controller is implemented on a mobile device or on a remote device located on a cloud infrastructure.

11. The system of claim 6, wherein the execution of the instructions is implemented in an agentic AI pipeline operation comprising at least one trained AI model selected from the group comprising the first trained AI model, the second trained AI model, and the third trained AI model.

12. A non-transitory computer-readable medium having instructions stored thereon, wherein execution of the instructions causes a processor to:
receive a first dataset comprising a plurality of activity descriptions for a subject;
generate, via a motion synthesis model, as a first trained AI model, a set of motion sequence data objects representing motion sequences corresponding with the plurality of activity descriptions, wherein each motion sequence data object represents a motion within the motion sequences, and wherein the generation of the set of motion sequence data objects includes an iterative data-variability evaluation operation;
generate, using the generated set of motion sequence data objects, a second dataset comprising a set of properties of each motion sequence; and
output the generated second dataset, wherein the output generated second data is subsequently used for training artificial intelligence (AI) or machine learning (ML) models to detect or recognize the activity of the subject.

13. The non-transitory computer-readable medium of claim 12, wherein the motion synthesis model is a neural network trained using a dataset comprising motion sequence data objects acquired from a set of subjects and coupled with corresponding descriptions of activities performed by the set of subjects.

14. The non-transitory computer-readable medium of claim 12, wherein the received first dataset is generated, via a second trained AI model, using data representing name or type of the activity of the subject as an input, wherein the second trained AI model is a large language model (LLM) trained using a dataset comprising descriptions of activities performed by a set of subjects.

15. The non-transitory computer-readable medium of claim 14, wherein the iterative data-variability evaluation operation comprises:
generating, in a given iteration, vectorial representations for the plurality of activity descriptions, wherein each vectorial representation includes semantic and syntactic data of a respective description within the first dataset, and wherein the vectorial representations form one or more vectorial clusters;
determining, in the given iteration, a diversity score value representing variability among the generated vectorial representations in the given iteration, including (i) distributions of the one or more vectorial clusters and (ii) spatial distances between centers of vectorial clusters and respective vectorial representations therein;
determining a difference between the determined diversity score value in the given iteration and a diversity score value in a previous iteration; and
in response to the determined difference exceeding a variability threshold among the generated vectorial representations, generating, in subsequent iterations, additional activity descriptions until a difference in diversity score values of two consecutive subsequent iterations fails to exceed the variability threshold.

16. The non-transitory computer-readable medium of claim 12, wherein the generation of the set of motion sequence data objects includes a second iterative operation comprising:
generating, in a given iteration, vectorial representations for the set of motion sequence data objects, wherein each vectorial representation corresponds to a respective motion sequence data object, and wherein the vectorial representations form one or more vectorial clusters;
determining, in the given iteration, a diversity score value representing variability among the generated vectorial representations in the given iteration, including (i) distributions of the one or more vectorial clusters and (ii) spatial distances between centers of vectorial clusters and respective vectorial representations therein;
determining a difference between the determined diversity score value in the given iteration and a diversity score value in a previous iteration; and
in response to the determined difference exceeding a variability threshold among the generated vectorial representations, generating, in subsequent iterations, additional motion sequence data objects until a difference in diversity score values in two consecutive subsequent iterations fails to exceed the variability threshold.

17. The non-transitory computer-readable medium of claim 15, wherein the execution of the instructions further causes the processor to remove, via a motion filtering operation, motion sequence data objects inconsistent with the plurality of activity descriptions, wherein the motion filtering operation comprises:
receiving the generated set of motion sequence data objects;
encoding, via a third trained AI model, the generated set of motion sequence data objects into a set of tokens, each token representing a respective motion sequence data object, wherein the third trained AI model was trained using a language dataset coupled with motion sequence data acquired from a set of people;
generating, via the third trained AI model, a set of motion descriptions, as input to the second trained AI model, for the generated set of motion sequence data objects encoded in the generated set of tokens;
determining, via the second trained AI model, one or more motion descriptions within the generated set of motion descriptions as being inconsistent with the plurality of activity descriptions; and
removing motion sequence data objects associated with the one or more motion descriptions determined as being inconsistent with the plurality of activity descriptions.

18. The non-transitory computer-readable medium of claim 17, wherein the determining of the one or more motion descriptions as being inconsistent with the plurality of activity descriptions comprises:
labeling motion descriptions within the generated set of motion descriptions with binary classification values, including a first binary classification value, and wherein the one or more motion descriptions determined as being inconsistent with the plurality of activity descriptions are labeled with the first binary classification value.

19. A method for generating training data for artificial intelligence (AI) or machine learning (ML) models to detect or recognize an activity of a subject, the method comprising:
receiving, via a processor, a first dataset comprising a plurality of activity descriptions for the subject;
generating, via a motion synthesis model, as a first trained AI model, a set of motion sequence data objects representing motion sequences corresponding with the plurality of activity descriptions, wherein each motion sequence data object represents a motion within the motion sequences, and wherein the generation of the set of motion sequence data objects includes an iterative data-variability evaluation operation;
generating, using the generated set of motion sequence data objects, a second dataset comprising a set of properties of each motion sequence; and
outputting, via the processor, the generated second dataset, wherein the output generated second data is subsequently used for training the AI or ML models to detect or recognize the activity of the subject.

20. The method of claim 19, wherein the iterative data-variability evaluation operation comprises:
generating, in a given iteration, vectorial representations for the plurality of activity descriptions, wherein each vectorial representation includes semantic and syntactic data of a respective description within the first dataset, and wherein the vectorial representations form one or more vectorial clusters;
determining, in the given iteration, a diversity score value representing variability among the generated vectorial representations in the given iteration, including (i) distributions of the one or more vectorial clusters and (ii) spatial distances between centers of vectorial clusters and respective vectorial representations therein;
determining, via the processor, a difference between the determined diversity score value in the given iteration and a diversity score value in a previous iteration; and
in response to the determined difference exceeding a variability threshold among the generated vectorial representations, generating, in subsequent iterations, additional activity descriptions until a difference in diversity score values of two consecutive subsequent iterations fails to exceed the variability threshold.
